(19) United States
(12) Patent Application Publication
(10) Pub. No.: US 2008/0273716 A1
(43) Pub. Date: Nov. 6, 2008

(54) Feedback Sound Eliminating Apparatus

(76) Inventors: Kosuke Saito, Hamamatsu-shi (JP); Takurou Sone, Hamamatsu-shi (JP); Ryo Tanaka, Hamamatsu-shi (JP); Toshiaki Ishibashi, Fukuroi-shi (JP); Katsuichi Osakabe, Hamamatsu-shi (JP)

Correspondence Address: PILLSBURY WINTHROP SHAW PITTMAN LLP, P.O BOX 10500, McLean, VA, 22102, US

(21) Appl. No.: 11/667,623

(22) PCT Filed: Mar. 29, 2006
(86) PCT No.: PCT/JP2006/307160

§ 371 Date: Sep. 17, 2007

(30) Foreign Application Priority Data
Sep. 27, 2005 (JP) 2005-279150
Nov. 25, 2005 (JP) 2005-340805
Dec. 16, 2005 (JP) 2005-363084

(51) Int. Cl. H04B 15/00

(52) U.S. Cl. 381/93

(57) ABSTRACT

A control unit gives acoustic environment instruction data to a picked up sound directionality control unit and an adaptive filter. According to this, the picked up sound directionality control unit generates a picked up sound signal constituted by a predetermined picked up sound directionality. The adaptive filter detects the picked up sound directionality from the acoustic environment instruction data, and reads out the filter parameter corresponding to this picked up sound directionality, from a memory. The adaptive filter sets a delay coefficient and a filter coefficient of an FIR filter, and generates a pseudo echo signal by an impulse response with respect to the received sound signal. Based on an error signal obtained by subtracting the pseudo echo signal from the picked up sound signal by an adder, the adaptive filter sets a more optimum filter parameter, and generates the next pseudo echo signal.

### PRIORITY CLAIM

Priority is claimed on Japanese Patent Application No. 2005-279150, filed with the Japanese Patent Office on Sep. 27, 2005, Japanese Patent Application No. 2005-340805 filed with the Japanese Patent Office on Nov. 25, 2005, and Japanese Patent Application No. 2005-363084 filed with the Japanese Patent Office on Dec. 16, 2005 filed with the Japanese Patent Office, the content of which is incorporated herein by reference.

### TECHNICAL FIELD

The present invention relates to a feedback sound eliminating apparatus which prevents acoustic echo or howling caused by sound emitted from a speaker being wrapped around a microphone and collected therein. In particular, it relates to a feedback sound eliminating apparatus using an adaptive filter.

### BACKGROUND ART

Conventionally, there are disclosed various devices using an adaptive filter in order to prevent acoustic echo or howling.

The echo erasing equipment in Japanese Patent Publication No. Sho 62-120734 comprises a plurality of microphones, and the transfer function of the transmission route from each microphone is updated and set by an error signal after elimination of echo, and the filter coefficient of a FIR filter (adaptive filter) is set by this transfer function.

The echo canceller in Japanese Patent No. 2938076 comprises a plurality of microphones, and a pseudo echo path property of each transmission route (echo path) is calculated from a transfer function at this time, and a plurality of integrated pseudo echo path properties that have been assumed in the past, and then a new integrated pseudo echo path property is set from this pseudo echo path property and the present transfer function.

However, in Japanese Patent Publication No. Sho 62-120734, since the filter coefficient of the adaptive filter is set using an error signal, it is necessary to keep updating the adaptive filter until the error signal converges, requiring time for setting the filter coefficient. Moreover, in Japanese Patent No. 2938076, since matrix operation is performed using the transfer function of the previous integrated pseudo echo path properties and the present transfer function, so as to calculate the present integrated pseudo echo path property, then complicated arithmetic processing is required for setting the coefficient of the adaptive filter.

In particular, recently, in an acoustic system using a speaker array formed by arranging a plurality of speakers, or a microphone array formed by arranging a plurality of microphones, in many cases the acoustic environment may be rapidly and nonlinearly changed by controlling the directionalities of these speaker array and microphone array. In such a situation, as in the respective patent documents described above, in the method of setting the present filter coefficient based on the previous error signal or filter setting contents, the setting of the filter coefficient can not follow the change of the acoustic environment, requiring a long time until the adaptive filter operates stably.

### DISCLOSURE OF THE INVENTION

Therefore, an object of the present invention is to provide a feedback sound eliminating apparatus which effectively eliminates a feedback sound by stably operating the adaptive filter in a short time, even if the acoustic environment is rapidly and nonlinearly changed.

A feedback sound eliminating apparatus of the present invention comprises: a control device which instructs an acoustic environment to both of a feedback sound eliminating device and an acoustic environment forming device which includes at least a speaker system and a microphone system, and realizes one of a plurality of acoustic environments; and a feedback sound eliminating device which generates a pseudo feedback sound signal based on a voice signal to be input into the speaker system, and subtracts the pseudo feedback sound signal from a picked up sound signal output from the microphone system. Moreover, the feedback sound eliminating device comprises: a storage device which stores a plurality of parameters for an adaptive filter, that are set respectively corresponding to the plurality of the acoustic environments; and an adaptive filter which, if an acoustic environment instruction is performed by the control device, reads out the pertinent parameter from the storage device, based on the acoustic environment instruction, generates the pseudo feedback sound signal using the read out parameter, and generates a pseudo feedback sound signal while continuously updating the parameter, based on the result obtained by subtracting a pseudo feedback sound signal at this point in time from the previous picked up sound signal.

In this configuration, when the acoustic environment is instructed by the control device, the acoustic environment forming device controls the directionalities of the speaker system and the microphone system, to form a predetermined acoustic environment. The adaptive filter of the feedback sound eliminating device reads out a parameter according to the acoustic environment instruction contents from the storage device and sets the parameter. Then, the adaptive filter performs filter processing of the voice signal using the set parameter, so as to generate a pseudo feedback sound signal. The feedback sound eliminating device obtains the output signal, by subtracting this pseudo feedback sound signal from the picked up sound signal. In this manner, at the time when the acoustic environment is changed, the adaptive filter generates the pseudo feedback sound signal, based on the parameter corresponding to the newly set acoustic environment that has been previously stored in the storage device. Then, after the initial processing after this change of the acoustic environment, a normal operation of the adaptive filter, that is, an operation to generate the pseudo feedback sound signal while sequentially updating the parameter to the optimum condition based on the previous error signal, is repeated.

As a result, even if the acoustic environment rapidly and nonlinearly changed, the initial parameter suitable for the new acoustic environment can be instantly set, and the optimum parameter can be obtained in a short time.

The present invention is a feedback sound eliminating apparatus, comprising: an acoustic environment forming device which includes at least a speaker system and a microphone system, and realizes one of a plurality of acoustic environments; a feedback sound eliminating device which generates a pseudo feedback sound signal based on a voice signal to be input into the speaker system, and subtracts the pseudo feedback sound signal from a picked up sound signal output from the microphone system; and a control device which instructs an acoustic environment to the acoustic environment forming device and the feedback sound eliminating device, wherein the control device comprises a storage device which stores a plurality of parameters for an adaptive filter, that are set respectively corresponding to the plurality of acoustic environments, and upon receipt of switching of the acoustic environment, detects an unused adaptive filter, writes a parameter corresponding to a newly set acoustic environment into the unused adaptive filter, and generates parameter rewriting state data; and the feedback sound eliminating device comprises a plurality of adaptive filters, and a selecting device which selects one of the plurality of adaptive filters as an execution adaptive filter, and upon detection of the parameter rewriting state data, switches from the currently executed adaptive filter to an adaptive filter having a parameter set corresponding to the new acoustic environment, by means of the selecting device, and generates the pseudo feedback sound signal.

In this configuration, when a switch instruction of the new acoustic environment is input, the control device reads out the parameter for the adaptive filter that has been previously set according to the nominated acoustic environment, and writes the read out parameter in the unused adaptive filter. At this time, the control device generates the parameter rewriting state data which means that the parameter was simultaneously rewritten. Upon detection of the parameter rewriting state data, the feedback sound eliminating device switches the operation from the currently executed adaptive filter to the adaptive filter having the parameter set corresponding to the new acoustic environment. This series of processing is performed each time when the adaptive filter is switched, that is, the acoustic environment is switched.

A feedback sound eliminating apparatus of the present invention comprises: an emitted sound control device which controls an emitted sound signal to be supplied to a speaker device, so as to give a plurality of styles of emitted sound directionalities to a voice emitted from the speaker device; a picked up sound control device which controls a picked up sound signal of a microphone device, and generates a directional picked up sound signal having a plurality of styles of picked up sound directionalities; a feedback sound eliminating device which has a plurality of adaptive filters which generate a pseudo feedback sound signal based on the emitted sound signal, and which subtracts the pseudo feedback sound signal generated by a predetermined adaptive filter, from the directional picked up sound signal; and a control device which has a storage device which stores initial parameters of the adaptive filter, in respective combinations of the plurality of styles of emitted sound directionalities and the plurality of styles of picked up sound directionalities, and gives initial parameters corresponding to styles of set emitted sound directionality and corresponding to styles of respectively different picked up sound directionalities, to the respective adaptive filters. The feedback sound eliminating device of the feedback sound eliminating apparatus comprises a selecting device which selects the predetermined adaptive filter, based on the style of the picked up sound directionality set by the picked up sound control device.

In this configuration, if the directionality control and the like of the speaker device by the user is performed, so as to switch the emitted sound directionality, then the control device instructs the emitted sound control device to change the emitted sound directionality. Moreover, the control device gives initial parameters corresponding to the set emitted sound directionality and corresponding to the respectively different picked up sound directionalities, to the respective adaptive filters of the feedback sound eliminating device.

If an input sound signal is emitted by a new emitted sound directionality and picked up by the microphone device, then the picked up sound control device sets the picked up sound directionality of the microphone device and generates a directional picked up sound signal. Moreover, the picked up sound control device gives information of the set picked up sound directionality to the selecting device of the feedback sound eliminating device.

Based on the obtained picked up sound directionality, the selecting device of the feedback sound eliminating device selects the corresponding adaptive filter. The selected adaptive filter generates the pseudo feedback sound signal, based on the input sound signal. By subtracting this pseudo feedback sound signal from the directional picked up sound signal, the feedback sound eliminating device performs echo cancelling to obtain an output sound signal.

In this manner, if the picked up sound environment is changed in a state where the emitted sound directionality is constant, the picked up sound control device sets the picked up sound directionality again, and generates a directional picked up sound signal corresponding to the new picked up sound directionality, and gives the new picked up sound directionality information to the selecting device. The selecting device switches the adaptive filter according to this new picked up sound directionality information, and the switched new adaptive filter generates the pseudo feedback sound signal. By repeating this processing, when the emitted sound directionality and the picked up sound directionality are changed, the adaptive filter is appropriately switched to execute echo cancelling.

Moreover, in the feedback sound eliminating apparatus of the present invention, upon receipt of a new acoustic environment instruction, the adaptive filter updates and stores the currently used parameter in the storage device, and reads out a parameter based on the new acoustic environment instruction.

In this configuration, the parameter optimized by the adaptive filter is fed back to the storage device, and stored. As a result, if the same acoustic environment instruction is performed next, the initial parameter setting contents come closer to the more optimum state for the instructed acoustic environment, and the optimum parameter can be obtained in an even shorter time.

Moreover, in the feedback sound eliminating apparatus of the present invention, the feedback sound eliminating device detects the presence/absence of the parameter rewriting state data at each previously set predetermined timing, and switches the adaptive filter by means of the selecting device, upon detection of the parameter rewriting state data.

In this configuration, the feedback sound eliminating device detects the presence/absence of the parameter rewriting state data at each previously set predetermined timing. That is, it detects whether or not the parameter is rewritten all the time at predetermined time intervals.

In the feedback sound eliminating apparatus of the present invention, the control device does not rewrite on an unused adaptive filter, but only generates the parameter rewriting state data, if the acoustic environment to be newly and switchingly input matches the acoustic environment before the currently executed acoustic environment.

In this configuration, if the newly instructed acoustic environment is the acoustic environment immediately before the currently executed acoustic environment, the control device identifies this and does not read out the corresponding parameter for the adaptive filter. Then, the control device generates the parameter rewriting state data showing a completion of rewriting. The feedback sound eliminating device switches the adaptive filter based on this parameter rewriting state data. Since the optimized parameter is held as is, in the switched adaptive filter according to the acoustic environment two times before switching the acoustic environment, then the feedback sound elimination processing is executed by the adaptive filter set by this parameter. As a result, the feedback sound elimination processing is started with the parameter suitable for the current state of the new acoustic environment, rather than the parameter previously stored in the control device. As a result, the optimization of the parameter, that is, the time to reach the optimum feedback sound elimination processing, is further sped up.

Moreover, in the feedback sound eliminating apparatus of the present invention, the control device temporarily stops the feedback sound eliminating device, at the time of switching of the emitted sound directionality, and switches the initial parameters of the adaptive filters.

In this configuration, if the emitted sound directionality is switched, the feedback sound eliminating device is temporarily stopped, and all adaptive filters are rewritten at once. As a result, it becomes possible to prevent an abnormal echo that is generated if the parameter rewriting is forcibly performed during the execution of the adaptive filter.

Moreover, in the feedback sound eliminating apparatus of the present invention; the speaker system is a speaker array, the acoustic environment is set by the directionality of the speaker, and the directionality of the speaker array is changed and the parameter of the adaptive filter is switched, according to the acoustic environment instruction.

In this configuration, the parameter of the adaptive filter is stored corresponding to the directionality of the speaker array, and the parameter is read out based on the instructed directionality of the speaker array, and set in the adaptive filter.

Moreover, in the feedback sound eliminating apparatus of the present invention; the microphone system is a microphone array, the acoustic environment is set by the directionality of the microphone, and the directionality of the microphone array is changed and the parameter of the adaptive filter is switched, according to the acoustic environment instruction.

In this configuration, the parameter of the adaptive filter is stored corresponding to the directionality of the microphone array, and the parameter is read out based on the instructed directionality of the microphone array, and set in the adaptive filter.

Moreover, in the feedback sound eliminating apparatus of the present invention; the speaker system is a speaker array and the microphone system is a microphone array, the acoustic environment is set by the directionality of the speaker and the directionality of the microphone, and the directionality of the speaker array and the directionality of the microphone array are changed and the parameter of the adaptive filter is switched, according to the acoustic environment instruction.

In this configuration, the parameter of the adaptive filter is stored corresponding to the directionalities of the speaker array and the microphone array, and the parameter is read out based on the instructed directionalities of the speaker array and the microphone array, and set in the adaptive filter.

Moreover, in the feedback sound eliminating apparatus of the present invention, the picked up sound control device specifies a sound source direction from a picked up sound signal output from the microphone device, and generates a directional picked up sound signal having a high picked up sound directionality in the specified direction, and gives the information of the picked up sound directionality corresponding to the pertinent directional picked up sound signal, to the selecting device.

In this configuration, the picked up sound control device specifies the sound source direction by itself, and sets a high picked up sound directionality in the direction. As a result, the optimum directional picked up sound signal according to the current picked up sound directionality detected by the picked up sound control device, can be generated. Then, by giving the information according to this picked up sound directionality to the selecting device, the adaptive filter optimum for the picked up sound signal directionality detected by this picked up sound control device, is selected.

According to the present invention, since the parameter suitable for the nominated acoustic environment is set in the adaptive filter at the initial time of changing, then even if a control is performed to rapidly and nonlinearly change the acoustic environment, the adaptive filter can be stably operated in a short time.

According to the present invention, a configuration comprising a plurality of adaptive filters wherein one adaptive filter is executed all the time, is used. Moreover, a parameter suitable for the newly nominated acoustic environment is set in an unused adaptive filter. According to the switch instruction of the acoustic environment, by switching from the currently used adaptive filter to the adaptive filter set with the parameter suitable for the new acoustic environment, then even if a control is performed to rapidly and nonlinearly change the acoustic environment, the optimum feedback sound elimination process can be performed in a short time.

According to the present invention, parameters of a plurality of adaptive filters are previously stored, according to the combination of emitted sound directionality/picked up sound directionality, and the optimum adaptive filter is selected according to the combination of emitted sound directionality/picked up sound directionality after switching. As a result, it becomes possible to switch to the optimum adaptive filter at higher speed than the conventional case, and the optimum feedback sound elimination process can be performed in a short time.

### BRIEF DESCRIPTION OF THE DRAWINGS

FIG. 1 is a block diagram showing the main parts of the echo canceller of a first embodiment.

FIG. 2A is a conceptual diagram of filter parameters stored in the memory 13 shown in FIG. 1.

FIG. 2B is a conceptual diagram of filter parameters stored in the memory 13 shown in FIG. 1.

FIG. 3 is a flowchart showing an echo cancel processing flow of the echo canceller of the first embodiment.

FIG. 4 is a block diagram showing the main parts of the echo canceller of a second embodiment.

FIG. 5 is a conceptual diagram of filter parameters stored in the memory 13 shown in FIG. 4.

FIG. 6A is a conceptual diagram of filter parameters stored in the memory of the echo canceller of a third embodiment.

FIG. 6B is a conceptual diagram of filter parameters stored in the memory of the echo canceller of the third embodiment.

FIG. 6C is a conceptual diagram of filter parameters stored in the memory of the echo canceller of the third embodiment.

FIG. 7 is a block diagram showing the main parts of the echo canceller of another configuration.

FIG. 8 is a block diagram showing the main parts of the echo canceller of a fourth embodiment.

FIG. 9A is a flowchart showing an echo cancel processing flow of the echo canceller of the fourth embodiment.

FIG. 9 B is a flowchart showing an echo cancel processing flow of the echo canceller of the fourth embodiment.

FIG. 10A shows the state change of respective addresses in a register 208.

FIG. 10B shows the state change of respective addresses in a register 208.

FIG. 10C shows the state change of respective addresses in a register 208.

FIG. 11 is a flowchart showing the echo cancel processing flow of the echo canceller of a fifth embodiment.

FIG. 12 is a flowchart showing the echo cancel processing flow of the echo canceller of a sixth embodiment.

FIG. 13 is a block diagram showing the main parts of an echo canceller having a speaker unit using a speaker array.

FIG. 14 is a block diagram showing the main parts of the echo canceller having a speaker unit using a speaker array wherein the microphone unit is a single microphone.

FIG. 15 is a block diagram showing the main parts of the echo canceller of a seventh embodiment, where three independent sound signals are input to emit a sound.

FIG. 16 is a block diagram showing the main parts of the echo canceller of an eighth embodiment.

FIG. 17 is a conceptual diagram showing a database of the respective initial parameters with respect to the emitted sound directionalities, stored in the memory 3070 of FIG. 16.

FIG. 18 shows an association state between the picked up sound directionality and the execution adaptive filter.

FIG. 19 is a state transition diagram for the control unit 307 and the echo cancelling units.

FIG. 20 shows a processing flow of the echo cancelling unit at the time of normal processing.

### BEST MODE FOR CARRYING OUT THE INVENTION

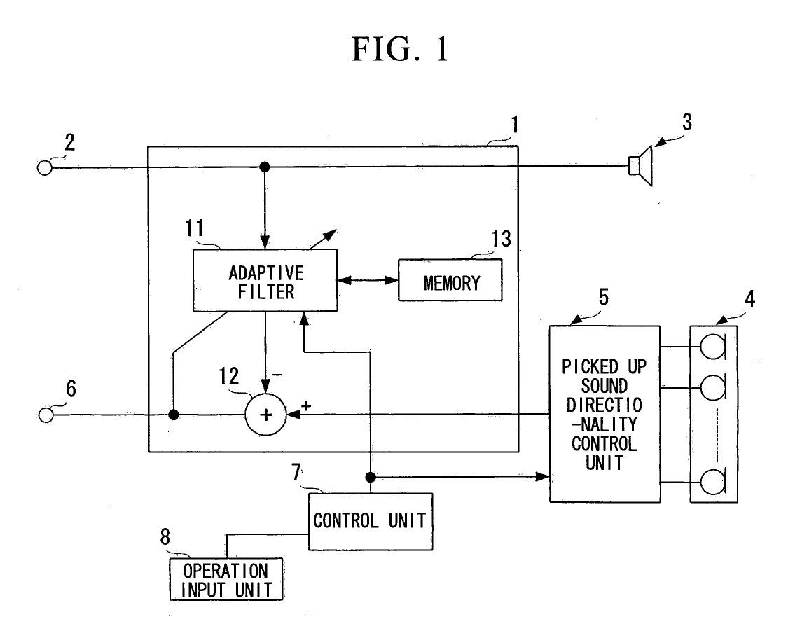

The feedback sound eliminating apparatus according to a first embodiment of the present invention is described, with reference to FIG. 1 to FIG. 3. The present embodiment is described using an echo canceller as an example of the feedback sound eliminating apparatus.

FIG. 1 is a block diagram showing the main parts of the echo canceller of the present embodiment.

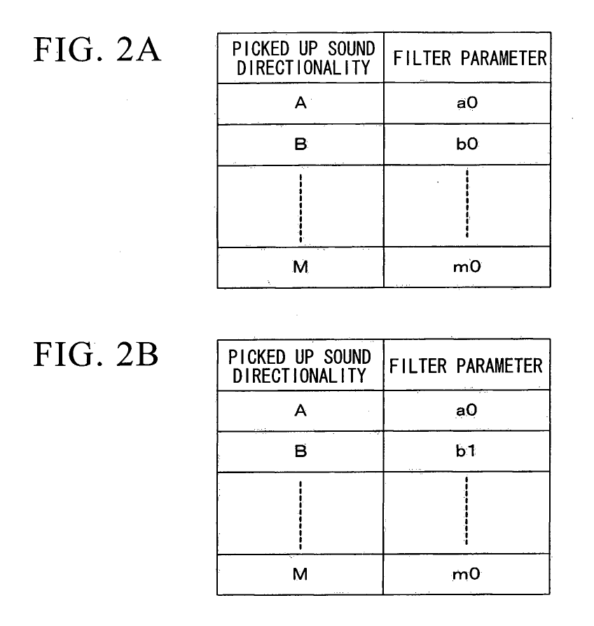

FIG. 2A is a conceptual diagram of filter parameters stored in the memory 13 shown in FIG. 1.

FIG. 2B is a conceptual diagram of filter parameters stored in the memory 13 shown in FIG. 1.

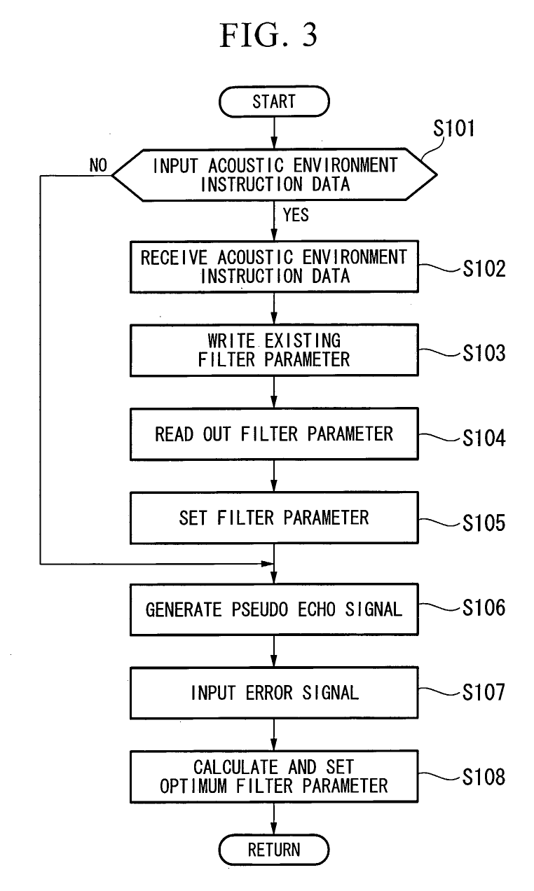

FIG. 3 is a flowchart showing an echo cancel processing flow of the echo canceller of the present embodiment.

The echo canceller of the present embodiment comprises an echo cancelling unit 1, a speaker unit 3, a microphone unit 4, a picked up sound directionality control unit 5, a control unit 7, and an operation input unit 8.

The control unit 7 controls the overall echo canceller, and gives acoustic environment instruction data to the picked up sound directionality control unit 5, and an adaptive filter 11 in the echo cancelling unit 1, based on an acoustic environment setting received from the operation input unit 8. The operation input unit 8 comprises an operating device such as a plurality of buttons, and receives various setting inputs from a user to give to the control unit 7.

The speaker unit 3 comprises a single speaker, and converts a received sound signal to emit a sound. The microphone unit 4 comprises a microphone array formed by arranging a plurality of microphones, and collects external sounds including sounds of conversations by calling parties by the respective microphones, and outputs to the picked up sound directionality control unit 5.

Based on the acoustic environment instruction data given from the control unit 7, the picked up sound directionality control unit 5 performs a delay addition of output signals from the respective microphones in the microphone array, and generates a picked up sound signal having a picked up sound directionality in a predetermined direction.

The echo cancelling unit 1 comprises an adaptive filter 11, an adder (subtractor) 12, and a memory 13. The adaptive filter 11 comprises a FIR filter. By setting a delay coefficient and a filter coefficient of this FIR filter to predetermined values, it generates a pseudo echo (feedback sound) signal using an impulse response with respect to the received sound signal input from the sound signal input terminal 2. The adder 12 subtracts the pseudo echo signal from the picked up sound signal input from the picked up sound directionality control unit 5, and outputs it. This output signal becomes an error signal and an outgoing sound signal. The outgoing sound signal is sent to the other party via the sound signal output terminal 6. The error signal returns to the adaptive filter 11.

As shown in FIG. 2A and FIG. 2B, the memory 13 previously stores filter parameters for respective picked up sound directionalities. Specifically, the filter parameter is set for each picked up sound directionality that is set by the microphone unit 4 and the picked up sound directionality control unit 5, and is configured by the delay coefficient and the filter coefficient of the FIR filter of the adaptive filter 11. For example, as shown in FIG. 2A, if A, and B to M of sound collection directionalities are present, only a0, and b0 to m0 of filter parameters are present corresponding to the respective sound collection directionalities A, and B to M. Moreover, detailed delay coefficients and filter coefficients are set for these respective filter parameters a0, and b0 to m0.

Next is a specific description of the operation of the adaptive filter 11, following the flowchart of FIG. 3.

When the user operates the operation input unit 8 to perform the acoustic environment setting, the control unit 7 generates acoustic environment instruction data to give to the adaptive filter 11.

When the acoustic environment instruction data is input from the control unit 7 (S101), the adaptive filter 11 receives this acoustic environment instruction data and identifies the instructed picked up sound directionality (S102).

The adaptive filter 11 reads out the respective delay coefficient and filter coefficient that are currently set for the FIR filter, and writes them into the memory 13, as a filter parameter corresponding to the pertinent picked up sound directionality (S103). At this time, the previous filter parameter (in the initial state or the state due to the previous update) is stored in the memory 13. However the adaptive filter 11 writes a new filter parameter over the filter parameter that is already stored. For example, in the initial state as shown in FIG. 2A, the stored filter parameter for the picked up sound directionality B is b0. However if the filter parameter b1 is present for the picked up sound directionality B in the adaptive filter 11, the adaptive filter 11 writes this filter parameter b1 over the filter parameter b0, as shown in FIG. 2B.

The adaptive filter 11 writes the filter parameter that has been set for itself, into the memory 13, and then it reads out a filter parameter corresponding to the identified picked up sound directionality (S104). Then, the adaptive filter 11 sets the delay coefficient and the filter coefficient of the FIR filter, based on the read out filter parameter (S105).

The adaptive filter 11 performs convolution or multiplication on the input received sound signal, with the delay coefficient and the filter coefficient (impulse response) set based on this acoustic environment instruction data, so as to generate a pseudo echo signal (S106). Then, as described above, the adder 12 subtracts the pseudo echo signal from the picked up sound signal, and outputs the result.

In this manner, at the same time when the acoustic environment is changed, by reading out and using the filter parameter corresponding to a new acoustic environment, stored in the memory 13, the filter parameter suitable for the acoustic environment can be obtained from the initial state after the acoustic environment is changed. Therefore, the filter parameter of the adaptive filter 11 can be optimized in a short time. As a result, stable echo cancelling can be realized in a short time.

The adaptive filter 11 inputs the error signal generated by the subtraction by the adder 12 (S107), then calculates and sets the optimum filter parameter at that point in time, using an already known learning identification method or the like (S108). If there is no input of acoustic environment instruction data, the adaptive filter 11 uses this optimized filter parameter to generate the pseudo echo signal (S101→S106).

The generation of this pseudo echo signal, input of the error signal, and calculation/setting of the optimum filter parameter (S106→S107→S108) are the normal operation of the adaptive filter 11, and is continuously executed unless the acoustic environment instruction data is input. As a result, the filter parameter is updated all the time, and gradually comes closer to the truly optimum filter parameter.

Moreover, if the acoustic environment instruction data is input, the adaptive filter 11 overwrites and stores the more optimized filter parameter for the current acoustic environment, in the memory 13. By performing such processing, if the same acoustic environment is set next time, the filter parameter optimized this time can be used. Therefore, the next time, the adaptive filter 11 can be optimized in a shorter time. As a result, stable echo cancelling can be realized in a shorter time.

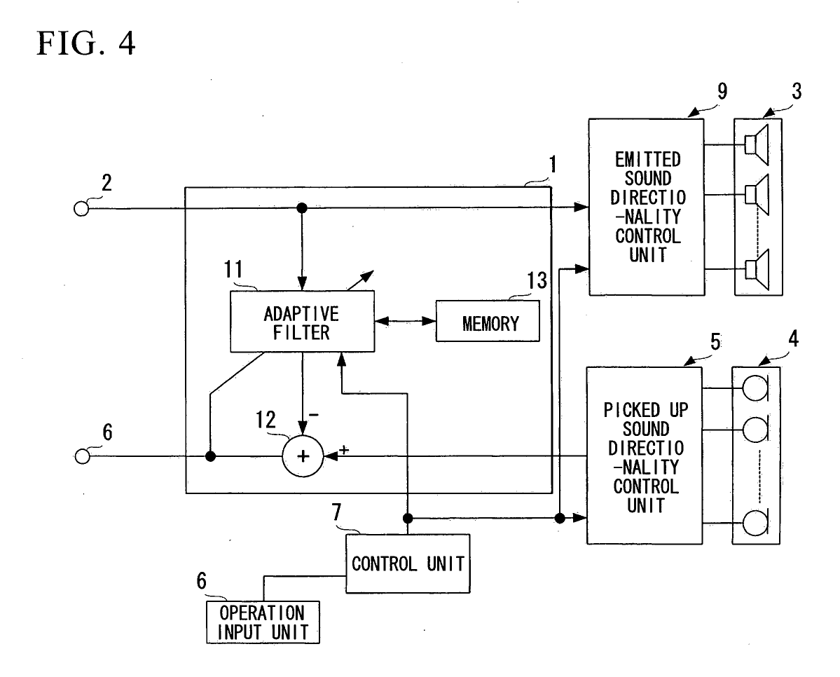

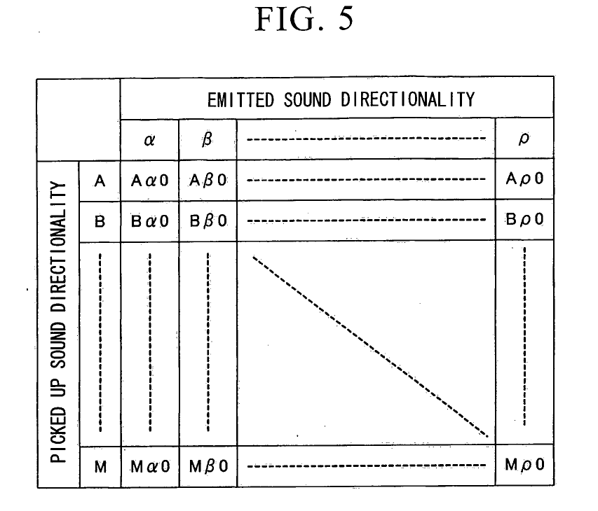

Next is a description of the feedback sound eliminating apparatus according to a second embodiment, with reference to FIG. 4 and FIG. 5. The present embodiment is also described using an echo canceller as an example of the feedback sound eliminating apparatus.

FIG. 4 is a block diagram showing the main parts of the echo canceller of the present embodiment.

FIG. 5 is a conceptual diagram of filter parameters stored in the memory 13 shown in FIG. 4.

In the echo canceller shown in FIG. 4, compared to FIG. 1, the speaker unit 3 comprises a speaker array formed by arranging a plurality of speakers, and an emitted sound directionality control unit 9 is inserted between the echo cancelling unit 1 and the speaker unit 3. Furthermore, the echo canceller shown in FIG. 4 gives the acoustic environment instruction data from the control unit 7 to the emitted sound directionality control unit 9 as well as to the picked up sound directionality control unit 5.

In such an echo canceller, when an acoustic environment setting is input, the control unit 7 gives the acoustic environment instruction data to the emitted sound directionality control unit 9 and the picked up sound directionality control unit 5. Based on the acoustic environment instruction data, the emitted sound directionality control unit 9 performs a delay control of sound signals which are to be output to the respective speakers in the speaker array, so as to control the directionality of a sound emitted from the speaker unit 3. The picked up sound directionality control unit 5 performs a delay control of output signals from the respective microphones in the microphone array, and generates a picked up sound signal having a picked up sound directionality in a predetermined direction.

In this manner, the speaker unit 3 is constituted by the speaker array, the microphone unit 4 is constituted by the microphone array, and by providing the emitted sound directionality control unit 9 and the picked up sound directionality control unit 5, a more diversified acoustic environment can be realized.

As shown in FIG. 5, in the memory 13, filter parameters are stored for each combination of the picked up sound directionality and the emitted sound directionality. For example, if A, and B to M of sound collection directionalities are present and α, and β to ρ of emitted sound directionalities are present, then Aα0 to Aρ0, Bα0 to Bρ0, etc. to Mα0 to Mρ0 of filter parameters corresponding to the respective combinations are set and stored.

When the acoustic environment instruction data is input from the control unit 7, the adaptive filter 11 analyzes this acoustic environment instruction data, to detect the pertinent combination of picked up sound directionality and emitted sound directionality. Then, the adaptive filter 11 reads out the corresponding filter parameter, and sets the delay coefficient and the filter coefficient of the FIR filter.

The other operation processing of the adaptive filter 11 is the same as for the first embodiment, and hence the description thereof is omitted.

In this manner, even in an acoustic environment capable of setting both of the emitted sound directionality and the picked up sound directionality, that is, an acoustic environment where various settings are possible more than those in the first embodiment, the setting may be performed by reading out the filter parameters stored in the memory. Therefore, the adaptive filter can be optimized in a short time according to the set acoustic environment, and stable echo cancelling can be realized

In particular, as with the present embodiment, if the acoustic environment is diverse, by using the configuration of the present invention, stable echo cancelling can be effectively realized in a shorter time than for a conventional case.

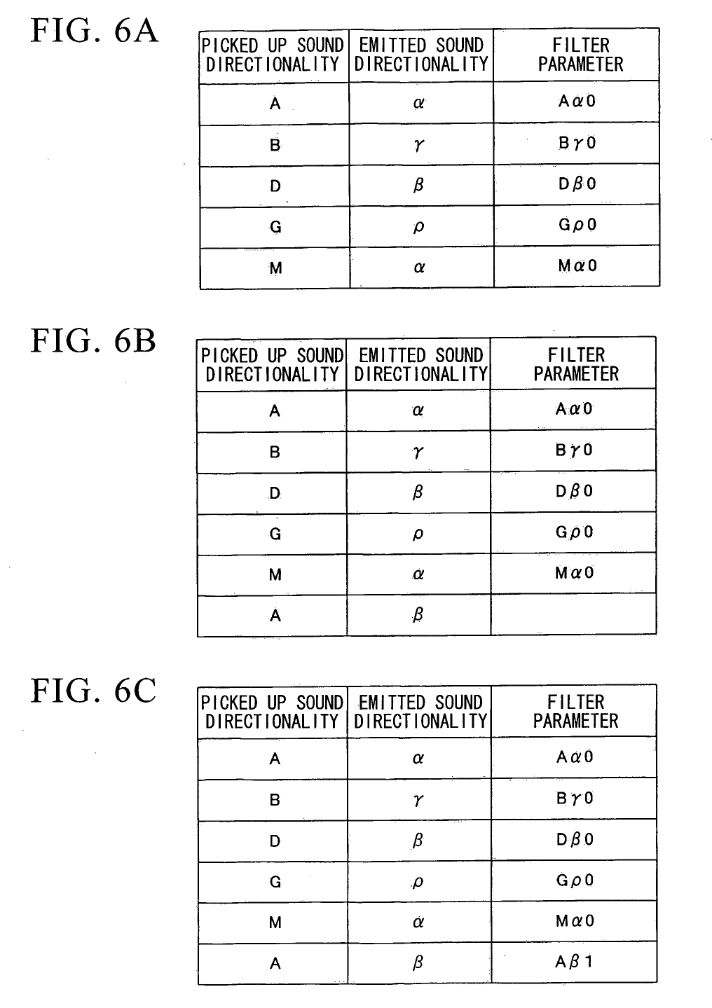

Next is a description of a feedback sound eliminating apparatus according to a third embodiment, with reference to FIG. 6A to FIG. 6C. The present embodiment differs from the apparatus shown in the second embodiment, in the method of storing and setting filter parameters, but the other configuration is the same. Therefore, the description of parts having the same configuration is omitted.

FIG. 6A to FIG. 6C are a conceptual diagram of filter parameters stored in the memory of the echo canceller of the present embodiment.

In the echo canceller of the present embodiment, only filter parameters of combinations of picked up sound directionality and emitted sound directionality that are previously known to be used, are preset and stored in the memory 13 (refer to FIG. 6A).

Moreover, if a stored combination (acoustic environment setting) of picked up sound directionality and emitted sound directionality is instructed, the echo canceller reads out a filter parameter corresponding to this combination and sets this in the adaptive filter 11.

By using such a configuration, the number of sets of the filter parameter and the combination of picked up sound directionality/emitted sound directionality stored in the memory 13 can be kept as small as possible, and thus the memory resource can be saved. In such a method of storing/setting a filter parameter, it is possible to execute the updating and storing of filter parameters as mentioned above.

Incidentally, when such a setting of filter parameters is performed, a combination of picked up sound directionality/emitted sound directionality that has not been previously set/stored may be instructed from the user, in some cases. In this case, the echo canceller may set the filter parameter of the adaptive filter 11 by any one of the following methods.

(1) Storing a filter parameter for general purpose irrespective of the contents of the combination of picked up sound directionality/emitted sound directionality.

(2) Continuously using the filter parameter before the acoustic environment is set by the user.

(3) Detecting a similar combination to the instructed combination of picked up sound directionality/emitted sound directionality, from already stored combinations of picked up sound directionality/emitted sound directionality, and using the filter parameter corresponding to this similar combination of picked up sound directionality/emitted sound directionality. For example, this is realized by putting an ID onto the respective sound collection directionalities and the respective emitted sound directionalities based on the characteristics of respective directionalities, and selecting a similar ID, from the characteristics of respective directionalities that have been newly set and detected by the user.

Furthermore, the echo canceller of the present embodiment may have a learning function of the filter parameter shown below.

If an unstored combination of picked up sound directionality/emitted sound directionality is instructed, the echo canceller ensures a region to store the filter parameter for this combination of picked up sound directionality/emitted sound directionality, in the memory 13 (refer to FIG. 6B).

Then, the adaptive filter 11 operates as with the abovementioned embodiments, and the filter coefficient is updated. Moreover, if a different acoustic environment is set by the user, the adaptive filter 11 stores the latest filter parameter that is set for itself, in the corresponding region (the abovementioned region that has been newly ensured) in the memory 13 (refer to FIG. 6C).

By setting such a configuration, the added combination of picked up sound directionality/emitted sound directionality, and the filter parameter are stored, and if the added combination of picked up sound directionality/emitted sound directionality is instructed again, the optimum filter coefficient can be obtained in a short time.

Moreover, as a method of storing a new filter parameter, if a region corresponding to the new filter parameter is ensured in the memory 13, for example there is also a method of deleting the set of the filter parameter and the combination of picked up sound directionality/emitted sound directionality having the least usage frequency or the shortest usage time. In this case, the usage frequency or the usage time is accumulated and stored together with the filter parameters and the combinations of picked up sound directionality/emitted sound directionality, in the memory 13. The adaptive filter 11 reads out this usage frequency or usage time, and sequences the sets of the filter parameter and the combination of picked up sound directionality/emitted sound directionality, and deletes a set at the bottom. Then, in the region formed by this processing, a new set of the filter parameter and the combination of picked up sound directionality/emitted sound directionality is stored.

In such a configuration, since the memory resource is saved and the readily used filter parameters are stored, then an echo canceller which is convenient to use with a limited memory, can be realized.

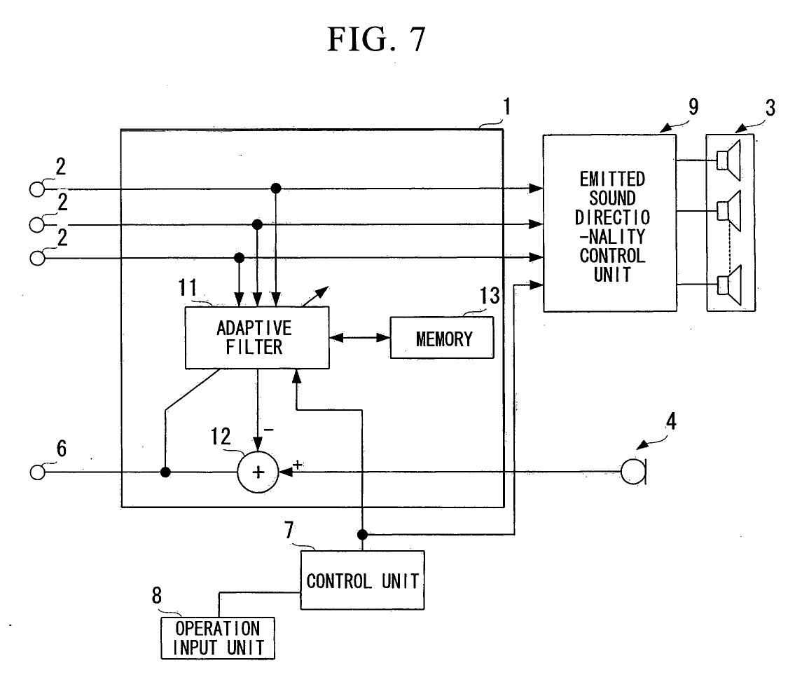

In the abovementioned respective embodiments, there is shown a case where there is one transmission line for received sound signals. However, as shown in FIG. 7, even in a case where a plurality of (three) transmission lines are present on the sound emission side, the abovementioned configuration can be applied so as to demonstrate the abovementioned effects.

FIG. 7 is a block diagram showing the main parts of the echo canceller of another configuration.

In the echo canceller shown in FIG. 7, there are three transmission lines for received sound signals. By performing a delay control or an amplitude control of each received sound signal by the emitted sound directionality control unit 9, for example in the speaker system 3 constituted by a speaker array, a plurality of virtual point sound sources are realized. Moreover, in the echo canceller shown in FIG. 7, the microphone unit 4 comprises only a single purpose microphone, and the picked up sound directionality control unit 5 is omitted.

In the case of such a constitution, the adaptive filter 11 comprises three function parts respectively corresponding to the respective channels, so as to generate pseudo echo signals for respective received sound signals of the channels in the respective function parts. In this case, in the memory 13, filter parameters are stored and set for respective emitted sound directionalities, corresponding to respective received sound signals.

It is also possible to constitute the microphone unit 4 by a microphone array, and to provide a picked up sound directionality control unit. In this case, filter parameters are stored and set for respective combinations of emitted sound directionality/picked up sound directionality, with respect to respective received sound signals.

Moreover, in the example shown in FIG. 7, there is shown a case where a plurality of virtual point sound sources are realized. However, even in a case where in reality a plurality of speakers are set to emit sounds, the configuration of the present invention can be applied. Furthermore, if the acoustic space (such as room size and shape) is variable in addition to the speaker unit and the microphone unit, the abovementioned configuration can be applied by setting filter parameters including these.

Moreover, in the above description, the coefficient of the adaptive filter is switched according to the emitted sound directionality of the speaker array and the picked up sound directionality of the microphone array. However, the respective embodiments of the present invention are not limited to the directionality control by the array. For example, even if there is only one speaker unit or one microphone unit, the present invention is applicable as long as the setting direction can be controlled and detected.

Moreover, the above description was regarding the echo canceller. However, as long as a device is such that a sound emitted from a speaker is wrapped around (regresses to) a microphone and collected, the configuration of the present invention may be applied to demonstrate the abovementioned effects. One example thereof includes a howling canceller.

Moreover, in the above description, there is shown a case where the filter parameter optimized by the adaptive filter 11 is written over in the memory 13. However, it may be such that this processing is not performed, and the filter parameter preset in the memory 13 is used at each time when the acoustic environment instruction data is received.

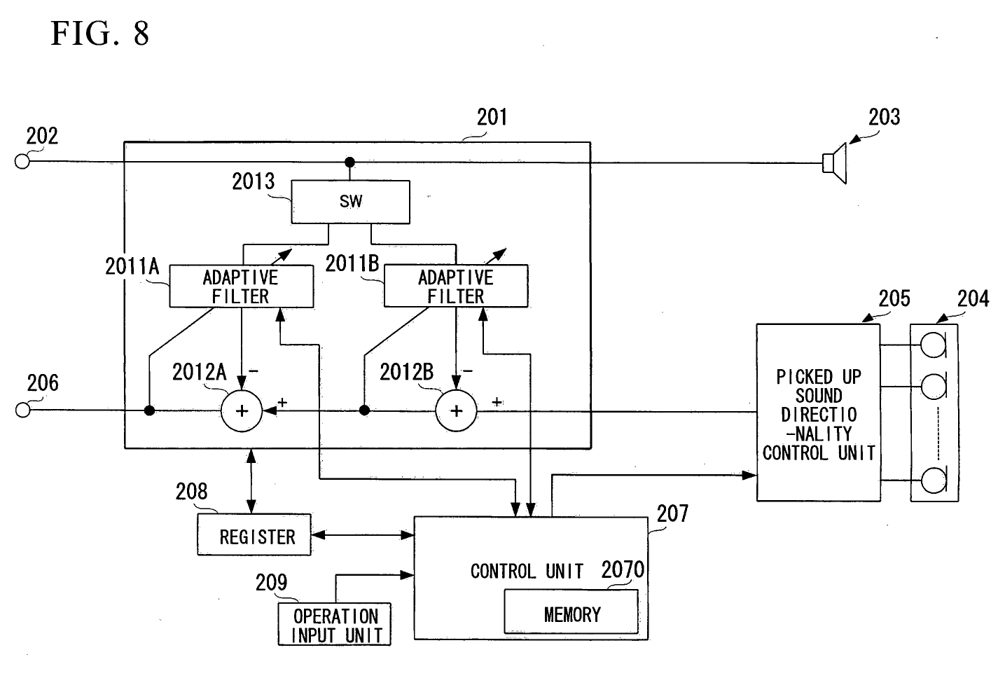

The feedback sound eliminating apparatus according to a fourth embodiment of the present invention is described, with reference to FIG. 8 to FIG. 10C. The present embodiment is described using an echo canceller as an example of the feedback sound eliminating apparatus.

FIG. 8 is a block diagram showing the main parts of the echo canceller of the present embodiment.

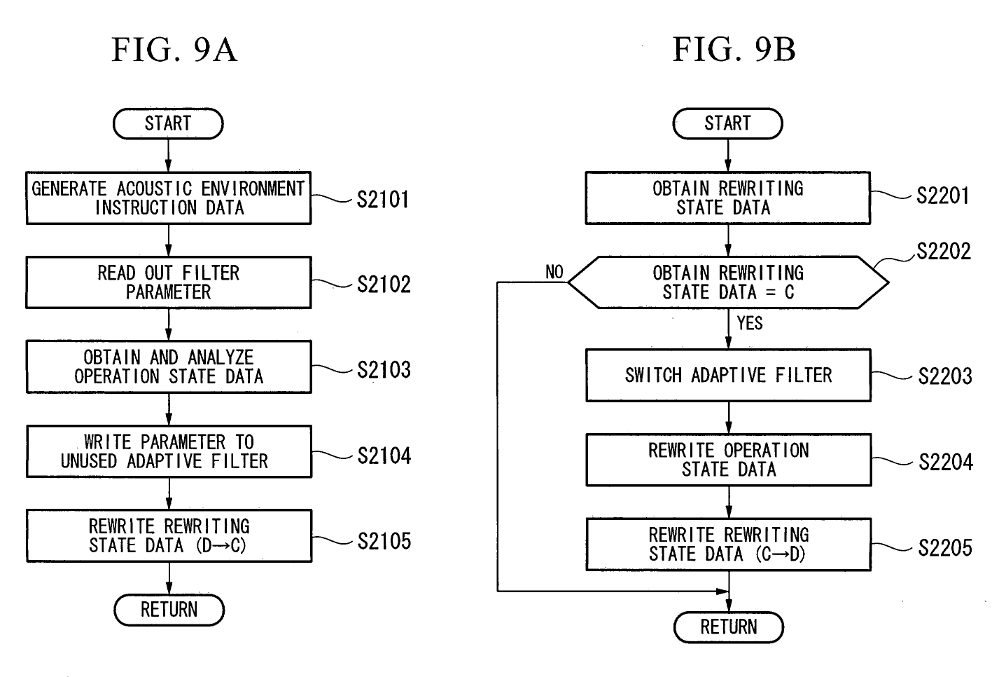

FIG. 9A and FIG. 9B are a flowchart showing an echo cancel processing flow of the echo canceller of the present embodiment, wherein FIG. 9A shows a processing flow of a control unit 207, and FIG. 9B shows a processing flow of an echo cancelling unit 201.

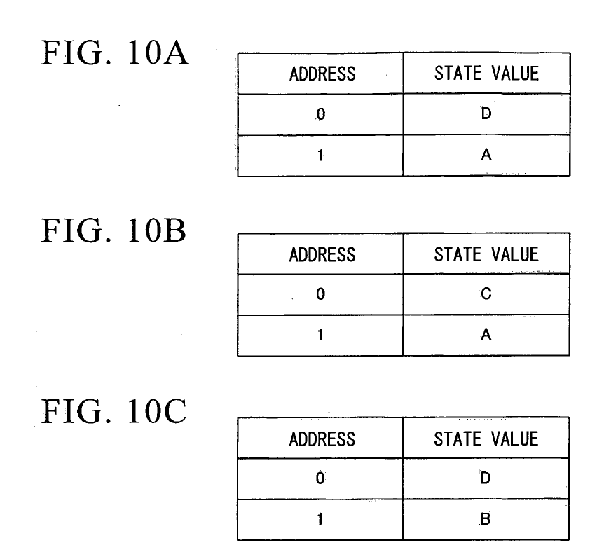

FIG. 10A to FIG. 10C show the state change of respective addresses in a register 208, wherein FIG. 10A shows a state where an adaptive filter 2011A is being executed, before a switch of the acoustic environment instruction data is received, FIG. 10B shows a state after the switch of the acoustic environment instruction data is received, but before the adaptive filter is switched (2011A→2011B), and FIG. 10C shows a state after the adaptive filter is switched (2011A→2011B).

The echo canceller of the present embodiment comprises an echo cancelling unit 201, a speaker unit 203, a microphone array 204, a picked up sound directionality control unit 205, a control unit 207, a register 208, and an operation input unit 209.

The control unit 207 controls the overall echo canceller, and generates acoustic environment instruction data, to give to the picked up sound directionality control unit 205, based on the contents of an acoustic environment setting received from the operation input unit 209. Moreover, the control unit 207 comprises a memory 2070 which stores filter parameters for the adaptive filters according to the respective acoustic environments, and reads out a filter parameter corresponding to the acoustic environment instruction data, so as to set it in the corresponding adaptive filter of the echo canceling unit 201. The operation input unit 209 comprises an operating device such as a plurality of buttons, and receives various setting inputs from a user to give to the control unit 207.

The speaker unit 203 comprises a single purpose speaker, and converts a received sound signal to emit a sound. The microphone unit 204 is formed by arranging a plurality of microphones, and picks up external sounds including sounds of conversations by calling parties by the respective microphones, and outputs to the picked up sound directionality control unit 205.

Based on the acoustic environment instruction data given from the control unit 207, the picked up sound directionality control unit 205 performs a delay addition of output signals from the respective microphones in the microphone array 204, and generates a picked up sound signal having a picked up sound directionality in a predetermined direction. The microphone unit is constituted by these microphone array 204 and picked up sound directionality control unit 205.

The echo cancelling unit 201 comprises adaptive filters 2011A and 2011B, post processors 2012A and 2012B, and a switch 2013, and is constituted from for example a DSP. The adaptive filters 2011A and 2011B comprise FIR filters and the like. The delay coefficients and the filter coefficients of these FIR filters are set to predetermined values, based on a filter parameter given from the control unit 207. As a result, an impulse response processing is performed with respect to the received sound signal input from the sound signal input terminal 202, so as to generate a pseudo echo (pseudo feedback sound) signal. The adaptive filters 2011A and 2011B have the same configuration except for the set filter parameter, and are selected by the switch 2013, so that any one of the adaptive filters operates all the time.

The post processor 2012A subtracts the pseudo echo signal generated by the adaptive filter 2011A, from the picked up sound signal input from the picked up sound directionality control unit 205, and outputs it. This output signal becomes an error signal and an outgoing sound signal. The outgoing sound signal is sent to the other party via the sound signal output terminal 206. The error signal returns to the adaptive filter 2011A.

The post processor 2012B subtracts the pseudo echo signal generated by the adaptive filter 2011B, from the picked up sound signal input from the picked up sound directionality control unit 205, and outputs it. This output signal becomes an error signal and an outgoing sound signal. The outgoing sound signal is sent to the other party via the sound signal output terminal 206. The error signal returns to the adaptive filter 2011B.

These post processors 2012A and 2012B are synchronized with the adaptive filters 2011A and 2011B. During the operation of the adaptive filter 2011A, the post processor 2012A operates. During the operation of the adaptive filter 2011B, the post processor 2012B operates. In the present description, the post processors 2012A and 2012B are respectively connected to the respective adaptive filters 2011A and 2011B. However, the structure may be such that two adaptive filters 2011A and 2011B may be selected and connected, with respect to one post processor.

As described later, according to the switching timing of the adaptive filter, the switch 2013 switches the adaptive filters 2011A and 2011B, so as to connect to the received sound signal transmission line from the sound signal input terminal 202 to the speaker unit 203.

As shown in FIG. 10A to FIG. 10C, the register 208 comprises two addresses, and stores a rewriting state data in No. “0” address. The rewriting state data consists of “C” and “D” rewriting state values. The rewriting state value C denotes a state after the rewriting is completed by the control unit 207, but before the adaptive filter of the echo cancelling unit 201 is switched. On the other hand, the rewriting state value D denotes a state after the adaptive filter of the echo cancelling unit 201 is switched, but before a parameter corresponding to a new acoustic environment setting is rewritten by the control unit 207. The operation state data is stored in No. “1” address. The operation state data consists of “A” and “B” operation state values. The operation state value A denotes a state where the adaptive filter 2011A is selected and being operated. The operation state value B denotes a state where the adaptive filter 2011B is selected and being operated.

Next is a detailed description of the processing in a case where the acoustic environment is switched, with reference to FIG. 9A to FIG. 10C.

In a state where the adaptive filter 2011A is selected and the abovementioned echo cancel processing is being operated, if the user instructs a new acoustic environment by operating the operation input unit 209 or the like, the control unit 207 receives this switch instruction of the acoustic environment. The control unit 207 detects the presence/absence of the switch instruction of the acoustic environment at each sampling timing. After the control unit 207 receives the switching of the acoustic environment, it generates the acoustic environment instruction data and gives this to the picked up sound directionality control unit 205 (S2101), and reads out the filter parameter corresponding to a newly set acoustic environment from the memory 2070 (S2102).

The control unit 207 reads out the address “1” of the register 208, to obtain the operation state value. Here, since the adaptive filter 2011A is currently selected and executed, the operation state value of the address “1” is “A”, and the control unit 207 obtains the operation state value “A”. When the control unit 207 obtains the operation state value “A”, it detects that the adaptive filter 2011B is unused (S2103).

Next, the control unit 207 gives the read out filter parameter corresponding to the new acoustic environment, to the unused adaptive filter 2011B (S2104). Then, as shown in FIG. 10B, the control unit 207 writes the rewriting state value “C” in the address “0” of the register 208, that is, rewrites the address “0” from the rewriting state value “D” to “C” (S2105). The data showing this rewriting state value “C” corresponds to the “parameter rewriting state data” of the present invention.

The echo cancelling unit 201 reads out the address “0” of the register 208 for each processing timing (for example, once per 80 sampling times) (S2201). Here, if the rewriting state value is “D”, the echo cancelling processing is continuously executed by the current adaptive filter. If the rewriting state value is “C”, the switch processing of the adaptive filter is performed (S2202→S2203). Then, when the echo cancelling unit 201 obtains the rewriting state value “C”, it switches from the adaptive filter 2011A to the adaptive filter 2011B.

After the filter switch processing is completed, then as shown in FIG. 10C, the echo cancelling unit 201 writes the operation state value “B” in the address “1” of the register 208, and writes the rewriting state value “D” in the address “0” (S2204 and S2205). In other words, the address “0” of the register 208 is returned to the state before switching the acoustic environment.

In this manner, by alternatively using two adaptive filters according to the switching of the acoustic environment, and by previously giving the filter parameter corresponding to the selected acoustic environment to the switched adaptive filter, effective echo cancelling can be performed right after the acoustic environment is switched. Furthermore, since the filter parameter of the switched adaptive filter can be optimized in a short time, stable echo cancelling can be realized in a short time.

In the above description, there is shown a case of switching from the adaptive filter 2011A to the adaptive filter 2011B. However, even in a case of switching from the adaptive filter 2011B to the adaptive filter 2011A, the execution may be performed by similar processing.

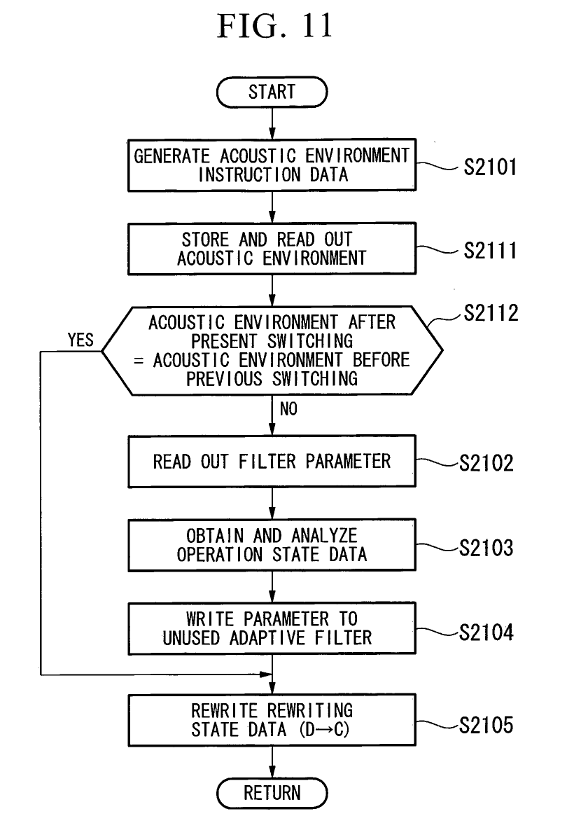

Next is a description of a feedback sound eliminating apparatus according to a fifth embodiment, with reference to FIG. 11. The present embodiment has approximately the same configuration as that of the fourth embodiment, having differences in the information stored in the memory 2070 of the control unit 207, and the processing flow of the control unit 207. Therefore, only the different parts are described, and the description of other parts is omitted.

FIG. 11 is a flowchart showing the echo cancel processing flow of the echo canceller of the present embodiment, showing the processing flow of the control unit 207.

In the present embodiment, the control unit 207 stores the acoustic environment that has been executed in the past, in the memory 2070. As with the fourth embodiment, if there are two adaptive filters, at least the acoustic environment (acoustic environment that is currently executed) before the present switching, and the acoustic environment before the previous switching are stored, and further past environments may also be stored.

If a new acoustic environment is detected, a filter parameter of an adaptive filter according to the acoustic environment is stored together with the acoustic environment for any time, in the memory 2070. However, if a predetermined storage amount is exceeded, the oldest acoustic environment is deleted, to thereby keep within the predetermined storage amount.

If a new acoustic environment is instructed, the control unit 207 generates acoustic environment instruction data to give to the picked up sound directionality control unit 205 (S2101). The control unit 207 stores the nominated acoustic environment in the memory 2070, and judges whether or not the acoustic environment stored this time, that is, the acoustic environment after the present switching, matches the acoustic environment before the previous switching (S2111→S2112). Then, if the acoustic environment after the present switching does not match the acoustic environment before the previous switching, then similarly to the fourth embodiment, the control unit 207 reads out the filter parameter to perform the switch processing (S2102 to S2105).

On the other hand, if the acoustic environment after the present switching matches the acoustic environment before the previous switching, the reading out of the filter parameter and the like (processing from S2102 to S2104) is omitted, and the control unit 207 writes the rewriting state value “C” in the address “0” of the register 208 (S2105).

Here, in the echo canceller which comprises two adaptive filters 2011A and 2011B, and which mutually executes them together with the switching of the acoustic environment, the filter parameter that has been optimized up to the time of the previous switching, is set for the present unused adaptive filter (before the present switching).

By utilizing this, the echo cancelling unit 201 of the present embodiment utilizes as is, the adaptive filter where the filter parameter optimized before the previous switching is set. As a result, at the time of switching, it becomes unnecessary to read out/write in the filter parameter, and to perform readout analysis of the address “1” of the register 208, thus simplifying the switch processing. Moreover, since the newly used filter parameter is the one that has been optimized at the point in time before the previous switching, then the filter parameter suitable for the acoustic environment after the present switching can be obtained in a shorter time. As a result, stable echo cancelling can be realized in a short time.

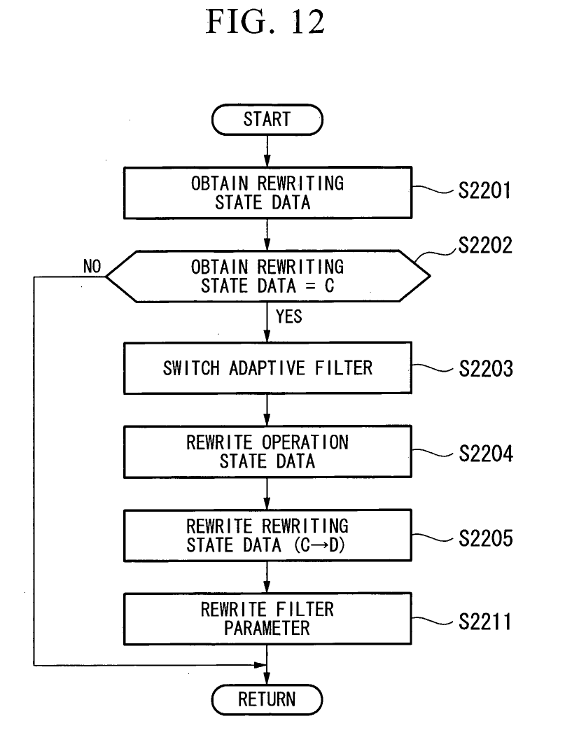

Next is a description of a feedback sound eliminating apparatus according to a sixth embodiment, with reference to FIG. 12. The present embodiment has approximately the same configuration as that of the fourth embodiment, having differences in the filter parameter stored in the memory 2070 of the control unit 207, and the processing flow of the echo cancelling unit 201. Therefore, only the different parts are described, and the description of other parts is omitted.

FIG. 12 is a flowchart showing the echo cancel processing flow of the echo canceller of the present embodiment, showing the processing flow of the echo cancelling unit 201.

After the switching of the adaptive filter is completed (S2203), the echo cancelling unit 201 rewrites and updates the rewriting state data and the operation state data with respect to the register 208 (S2204 and S2205), and stores the filter parameter that has been stored in the adaptive filter being executed, in the memory 2070 of the control unit 207 (S2211).

By using such processing, the newest filter parameter obtained by the echo cancelling unit 201 for each acoustic environment is stored in the memory 2070. Therefore, if the newly set acoustic environment matches the acoustic environment that has been executed in the past, the filter parameter which is the most suitable for the current state, can be given to the switched adaptive filter. As a result, stable echo cancelling can be realized in a shorter time.

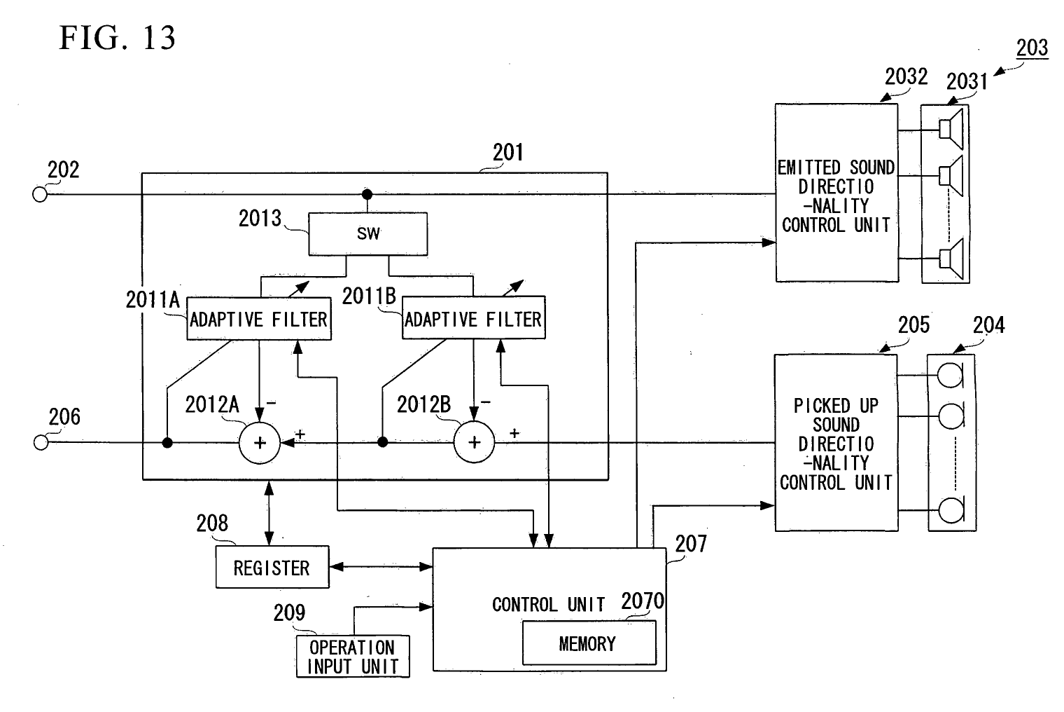

In the abovementioned respective embodiments, there is shown a case where the speaker unit is a single purpose speaker. However, as shown in FIG. 13, the above configuration is applicable even to a speaker unit using a speaker array.

FIG. 13 is a block diagram showing the main parts of the echo canceller having the speaker unit using the speaker array.

The speaker unit 203 of the echo canceller of the present embodiment comprises a speaker array 2031 having a plurality of speakers in an array, and an emitted sound directionality control unit 2032. Based on the acoustic environment instruction data given from the control unit 207, the emitted sound directionality control unit 2032 performs delay processing, amplitude processing, and the like of the received sound signal from the sound signal input terminal 202, and gives the result to the respective speakers in the speaker array 2031.

In such a configuration, by storing the filter parameter for each acoustic environment set by the emitted sound directionality and the picked up sound directionality, the above configuration can be applied. Moreover, even in such an acoustic environment where the emitted sound directionality and the picked up sound directionality are both changed, stable echo cancelling can be realized in a short time.

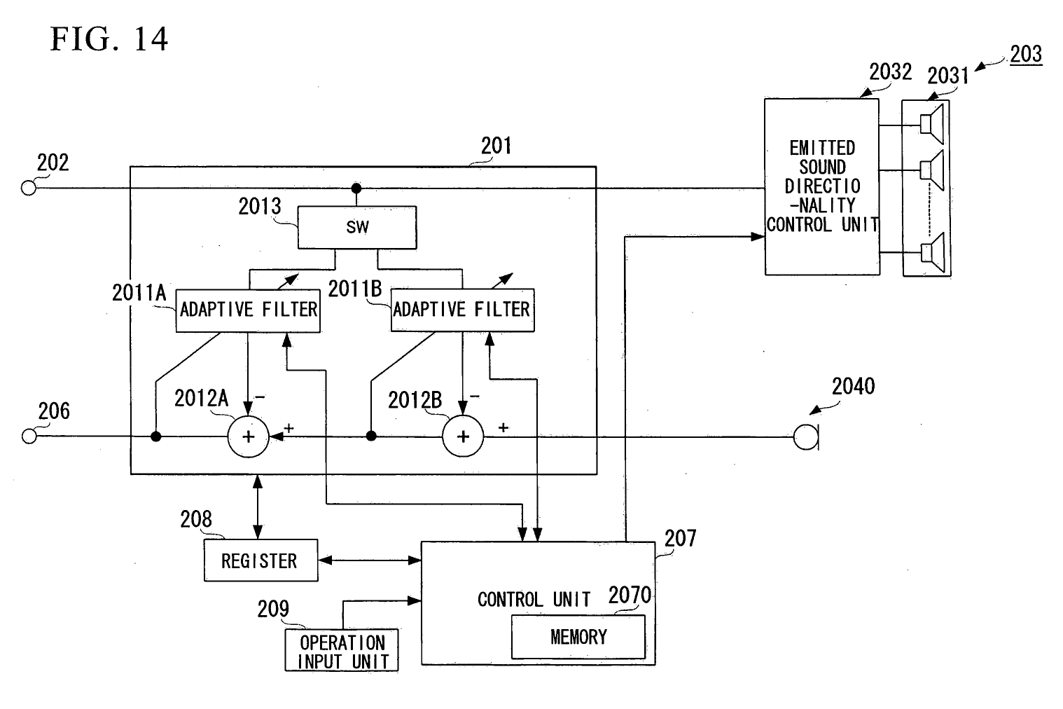

Moreover, as shown in FIG. 14, even if the speaker unit comprises the same speaker array as that of FIG. 13 and the microphone unit is a single purpose microphone, the abovementioned configuration can be similarly applied. FIG. 14 is a block diagram showing the main parts of the echo canceller having a speaker unit using a speaker array wherein the microphone unit is a single purpose microphone.

In this echo canceller, the microphone unit is only a single purpose microphone 2040, and the acoustic environment is set only by the emitted sound directionality. Even in such a case, by setting the filter parameter according to the acoustic environment set only by the emitted sound directionality, then similarly to the abovementioned respective cases, stable echo cancelling can be realized in a short time.

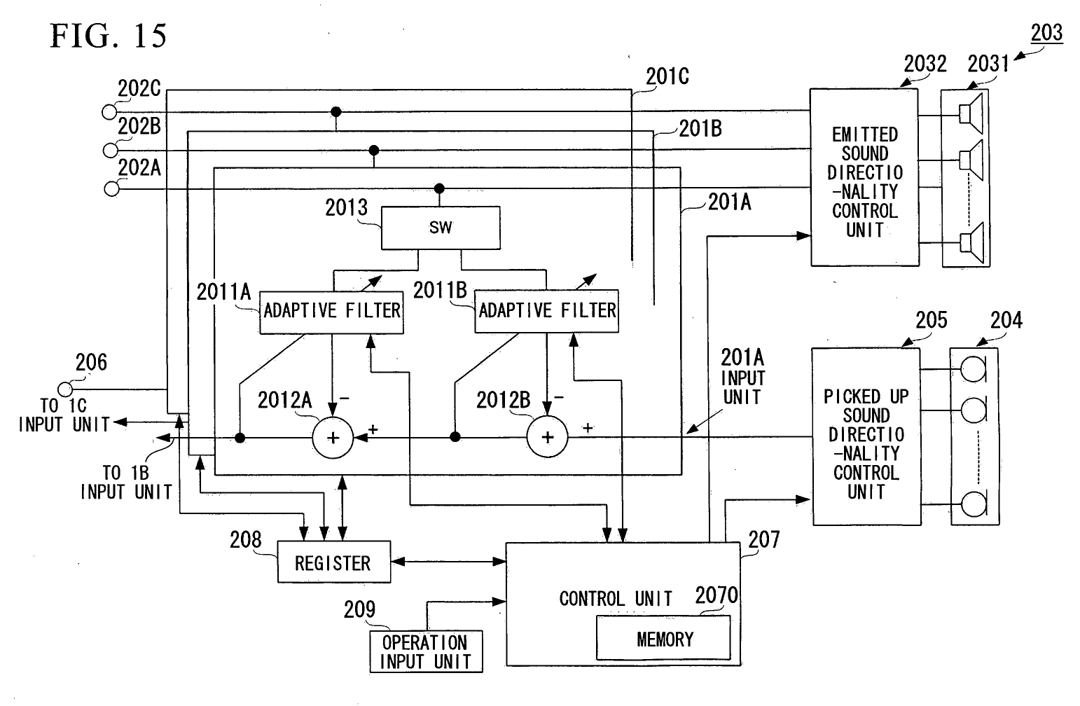

Next is a description of a feedback sound eliminating apparatus according to a fourth embodiment, with reference to FIG. 15.

FIG. 15 is a block diagram showing the main parts of the echo canceller where three independent sound signals are input to emit a sound.

The echo canceller of the present embodiment shows a case where sound signal input terminals 202A to 202C are present, and three independent sound signal routes are present. The sound signals input from the respective sound signal input terminals 202A to 202C are given to the emitted sound directionality control unit 2032. Based on the acoustic environment instruction data given from the control unit 207, the emitted sound directionality control unit 2032 sets virtual point sound sources and the like, and performs delay processing and amplitude processing of the respective sound signals corresponding to the setting of the virtual point sound sources, and gives the result to the respective speakers in the speaker unit 2031.

The echo cancelling units 201A, 201B, and 201C are connected corresponding to the received sound signal routes from the respective sound signal input terminals 202A, 202B, and 202C. Moreover, each one of the echo cancelling units 201A, 201B, and 201C respectively has two adaptive filters, comprising the same configuration.

Based on the acoustic environment instruction data given from the control unit 207, the picked up sound directionality control unit 205 performs a delay addition of the output signals from the respective microphones in the microphone array, and generates a picked up sound signal having a picked up sound directionality in a predetermined direction. This picked up sound signal is input into the echo cancelling unit 201A, added with the pseudo echo signal generated based on the received sound signal from the sound signal input terminal 202A, and then output to the echo cancelling unit 201B. The output signal of the echo cancelling unit 201A is input into the echo cancelling unit 201B, added with the pseudo echo signal generated based on the received sound signal from the sound signal input terminal 202B, and then output to the echo cancelling unit 201C.

The output signal of the echo cancelling unit 201B is input into the echo cancelling unit 201C, added with the pseudo echo signal generated based on the received sound signal from the sound signal input terminal 202C, and then output to the output terminal 206. The order of the respective echo cancelling units 201A, 201B, and 201C is not limited to the order of 201A→201B→201C as shown in FIG. 15, and it may be any configuration through which all of the echo cancelling units 201A, 201B, and 201C pass.

In the register 208, the operation state data and the rewriting state data are respectively stored with respect to the respective echo cancelling units 201A, 201B, and 201C.

With respect to each acoustic environment that can be taken by the device, the control unit 207 sets the acoustic environment for each received sound signal input from the sound signal input terminals 202A, 202B, and 202C, and previously stores the corresponding filter parameter in the memory 2070.

When the control unit 207 obtains a new acoustic environment instruction, it sets the acoustic environment for each received sound signal input from the sound signal input terminals 202A, 202B, and 202C, and reads out the corresponding filter parameter. Moreover, the control unit 207 reads out the operation state data of the respective echo cancelling units 201A, 201B, and 201C stored in the register 208, detects the unused adaptive filters for the respective echo cancelling units 201A, 201B, and 201C, and gives the respectively corresponding filter parameters to the respective adaptive filters. Moreover, the control unit 207 writes the rewriting state data showing the completion of rewriting, in the addresses of the register 208 corresponding to the respective echo cancelling units 201A, 201B, and 201.

When each of the echo cancelling units 201A, 201B, and 201C detects the rewriting state data showing the completion of rewriting, that has been written in the register 208, the adaptive filter to be used is switched. Then, each of the echo cancelling units 201A, 201B, and 201C writes the rewriting state data showing the completion of rewritten, in the corresponding address in the register 208.

In this manner, even in the case where a plurality of received sound signal routes are present and a plurality of echo cancelling units according to these are present, then similarly to the abovementioned embodiments, optimum echo cancelling can be performed in a short time at the time of switching the acoustic environment.

In the present embodiment, the contents of the above fifth embodiment and the sixth embodiment can be also applied.

Moreover, in the example shown in FIG. 15, there is shown a case where a plurality of virtual point sound sources are realized. However, even in a case where in reality a plurality of speakers are set to emit sounds, the configuration of the present invention can be applied. Furthermore, if the acoustic space (such as room size and shape) is variable in addition to the speaker unit and the microphone unit, the abovementioned configuration can be applied by setting filter parameters including these.

Moreover, in the above description, the picked up sound directionality direction is instructed by the operation input unit 209. However, for example if the picked up sound directionality control unit 205 has a function of estimating the sound source position, information of the picked up sound directionality direction may be given from the picked up sound directionality control unit 205 to the control unit 207, so as to switch the parameter of the adaptive filter.

Moreover, in the above description, the filter parameter of the adaptive filter is switched according to the emitted sound directionality of the speaker array and the picked up sound directionality of the microphone array. However, the respective embodiments of the present invention are not limited to the directionality control by the array. For example, even if there is only one speaker unit or one microphone unit, the present invention is applicable as long as the setting direction can be controlled and detected. Furthermore, even if there are a plurality of independent speaker units and microphone units, the present invention is similarly applicable.

Moreover, the above description was regarding the echo canceller. However, as long as a device is such that a sound emitted from a speaker is wrapped around (regresses to) a microphone and picked up, the configuration of the present invention may be applied to demonstrate the abovementioned effects. One example thereof includes a howling canceller.

Furthermore, in the above description, a method of completely switching the directionality, and the adaptive filter to be executed, is used together with switching of the acoustic environment. However, the present invention is also applicable to a case where so called cross fade processing is performed, where the echo cancelling control is gradually switched from the directionality before switching to the directionality after switching. In this case, a fader may be used instead of the switch 2013, so as to perform processing for gradually shifting the input level of the output signal, from the adaptive filter used before switching to the adaptive filter used after switching.

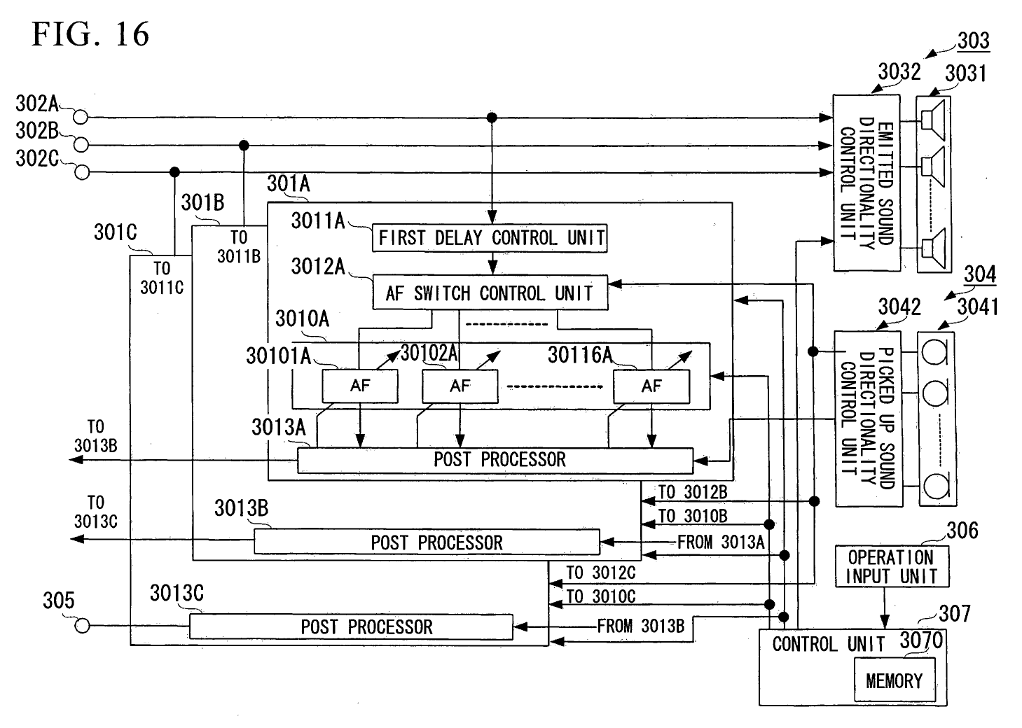

The feedback sound eliminating apparatus according to the embodiment of the present invention is described, with reference to FIG. 16 to FIG. 20. The present embodiment is described using an echo canceller as an example of the feedback sound eliminating apparatus. The echo canceller of the present embodiment shows a case where respectively independent sound signals are input from three sound signal input terminals 302A to 302C, to emit sounds.

FIG. 16 is a block diagram showing the main parts of the echo canceller of the present embodiment.

The echo canceller of the present embodiment comprises echo cancelling units 301A to 301C, sound signal input terminals 302A to 302C, a speaker array 3031, an emitted sound directionality control unit 3032, a microphone array 3041, a picked up sound directionality control unit 3042, a voice output terminal 305, an operation input unit 306, and a control unit 307. The echo cancelling units 301A to 301C comprises the same configuration.

The operation input unit 306 comprises a control which receives the setting of the emitted sound directionality. When the setting of the emitted sound directionality is input by the user or the like, the setting contents of the emitted sound directionality according to this operation is given to the control unit 307.

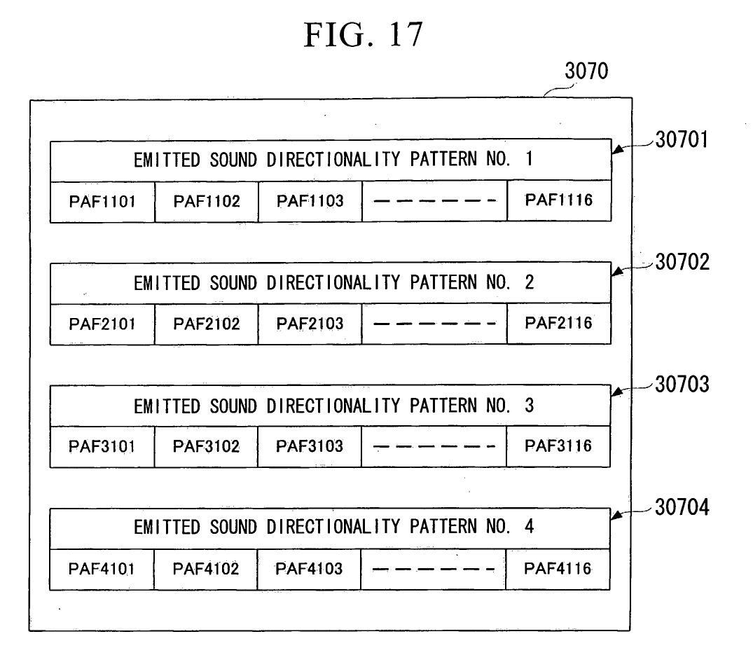

Based on the obtained emitted sound directionality setting contents, the control unit 307 generates the emitted sound directionality instruction data to give to the emitted sound directionality control unit 3032. As shown in FIG. 17, the control unit 307 sets four emitted sound directionalities of the emitted sound directionality patterns No. 1 to No. 4, with respect to the emitted sound directionality control unit 3032. These emitted sound directionality patterns No. 1 to No. 4 are set with the respective directions and focal points as factors, and with these configurations made different. The control unit 307 comprises a memory 3070 which stores the initial parameters as shown in FIG. 17.

FIG. 17 is a conceptual diagram showing a database of the respective initial parameters with respect to the emitted sound directionalities, stored in the memory 3070.

As shown in FIG. 17, in the memory 3070, as a database of the initial parameters, initial parameters that are to be given to the adaptive filters 30101A to 30116A in the echo cancelling unit 301A described later (not shown, but also the adaptive filters in the echo cancelling unit 301B and the adaptive filters in the echo cancelling unit 301C), are stored for each emitted sound directionality.

Specifically, it has: a parameter group 30701 comprising initial parameters PAF1101 to PAF1116 of the respective adaptive filters 30101A to 30116A with respect to the emitted sound directionality No. 1; a parameter group 30702 comprising initial parameters PAF2101 to PAF2116 of the respective adaptive filters 30101A to 30116A with respect to the emitted sound directionality No. 2; a parameter group 30703 comprising initial parameters PAF3101 to PAF3116 of the respective adaptive filters 30101A to 30116A with respect to the emitted sound directionality No. 3; and a parameter group 30704 comprising initial parameters PAF4101 to PAF4116 of the respective adaptive filters 30101A to 30116A with respect to the emitted sound directionality No. 4.

Here, the initial parameters of the respective adaptive filters 30101A to 30116A corresponding to one emitted sound directionality are set corresponding to the respectively different picked up sound directionalities.

For example, in the example of FIG. 17, in the style of the emitted sound directionality pattern No. 1 and the picked up sound directionality pattern No. 1, the initial parameter PAF1101 is set and this initial parameter PAF1101 is given to the adaptive filter 30101A. Moreover, in the style of the emitted sound directionality pattern No. 1 and the picked up sound directionality pattern No. 2, the initial parameter PAF1102 is set and this initial parameter PAF1102 is given to the adaptive filter 30102A. The adaptive filters are set in the same manner. In the style of the emitted sound directionality pattern No. 1 and the picked up sound directionality pattern No. 16, the initial parameter PAF1116 is set and this initial parameter PAF1116 is given to the adaptive filter 30116A.

In other words, the initial parameter PAF is set for each combination of the emitted sound directionality and the picked up sound directionality executed by the present echo canceller, and stored in the memory 3070. In the present embodiment, there is shown a case where the initial parameters are set for four emitted sound directionalities No. 1 to No. 4. However the number of the set emitted sound directionalities can be suitably set.

The initial parameters are set also for the echo cancelling units 301B and 301C, similarly to the echo cancelling unit 301A.

The control unit 307 detects the emitted sound directionality included in the acoustic environment instruction data, and reads out the initial parameter group corresponding to the set emitted sound directionality from the memory 3070. Then, the control unit 307 gives the read out initial parameter group to the respective adaptive filters 30101A to 30116A in the adaptive filter group 3010A in the echo cancelling unit 301A, and rewrites the parameters. At this time, the respective adaptive filters in the adaptive filter groups 30101B and 3010C in the echo cancelling units 301B and 301C are also rewritten in the same manner.

The sound signal input terminals 302A to 302C are connected for example to a LAN, to input respectively independent sound signals, so as to give these input sound signals to the emitted sound directionality control unit 3032. Moreover, the input sound signal of the sound signal input terminal 302A is given to the echo cancelling unit 301A, the input sound signal of the sound signal input terminal 302B is given to the echo cancelling unit 301B, and the input sound signal of the sound signal input terminal 302C is given to the echo cancelling unit 301C.

Based on the acoustic environment instruction data given from the abovementioned control unit 307, the emitted sound directionality control unit 3032 sets virtual point sound sources and the like, and performs delay processing and amplitude processing of the respective input sound signals corresponding to the setting of the virtual point sound sources, and generates emitted sound signals, and gives these to the respective speakers in the speaker array 3031.

The speaker array 3031 is constituted by arranging a plurality of speakers in a linear or matrix array, and emits an emitted sound signal given from the emitted sound directionality control unit 3032.

The microphone array 3041 is constituted by arranging a plurality of microphones in a linear or matrix array, and picks up external sounds with the respective microphones, and gives these to the picked up sound directionality control unit 3042.

The picked up sound directionality control unit 3042 is constituted by a DSP or the like. Using the picked up sound signal input from each microphone in the microphone array 3041, it detects the sound source direction of the sound signal which is output as the output sound signal, for example an incoming direction of a voice generated from a speaker serving as the target, for each predetermined timing, and sets the direction as a specified direction. Here, as an example of the method of detecting this specified direction, the picked up sound signals of the respective microphones are respectively synthesized by delay processing having different directionalities, so as to form directional picked up sound signals, and the signal strength (amplitude) of the respective directional picked up sound signals are compared.

Then, the direction corresponding to the directional picked up sound signal having the greatest signal strength, is set as the specified direction, and the directional picked up sound signal having the greatest signal strength is set as the directional picked up sound signal to be given to the echo cancelling unit 301A. The picked up sound directionality control unit 3042 gives information (hereunder, called picked up sound directionality data) of the picked up sound directionality pattern corresponding to the set specified direction, to the AF switch control unit 3012A of the echo cancelling unit 301A, the AF switch control unit 3012B of the echo cancelling unit 301B, and the AF switch control unit 3012C of the echo cancelling unit 301C.

Moreover, at each processing timing other than the detection timing of the specified direction, the picked up sound directionality control unit 3042 performs picked up sound directionality control corresponding to the specified direction at the point in time, and then performs delay processing and amplitude processing for each picked up sound signal input from each microphone, so as to generate the directional picked up sound signal, and gives this to the post processor 3013A in the echo cancelling unit 301A.

The echo cancelling units 301A to 301C comprise the same configuration. Hereunder is a detailed description of the echo cancelling unit 301A. The respective parts of the echo cancelling units 301B and 301C are cited as required.

The echo cancelling unit 301A comprises a first delay control unit 3011A, an AF switch control unit 3012A, an adaptive filter group 3010A, and a post processor 3013A.

The first delay control unit 3011A is constituted by a programmable delay. The first delay control unit 3011A gives a delay which is initially and systematically held by the present echo canceller, and is irrelevant to the abovementioned switching of the emitted sound directionality or the picked up sound directionality, and a delay which is essentially generated, corresponding to the voice transmission time through the shortest transmission route from the speaker array 3031 to the microphone array 3041, to the input sound signal that is input from the sound signal input terminal 302A. Similarly, the first delay control units 3011B and 3011C of the echo cancelling units 301B and 301C respectively give the essentially generated delay, to the input sound signals input from the sound signal input terminals 302B and 302C. As a result, waste of the tap length of the respective adaptive filters in the echo cancelling units 301A to 301C can be omitted.

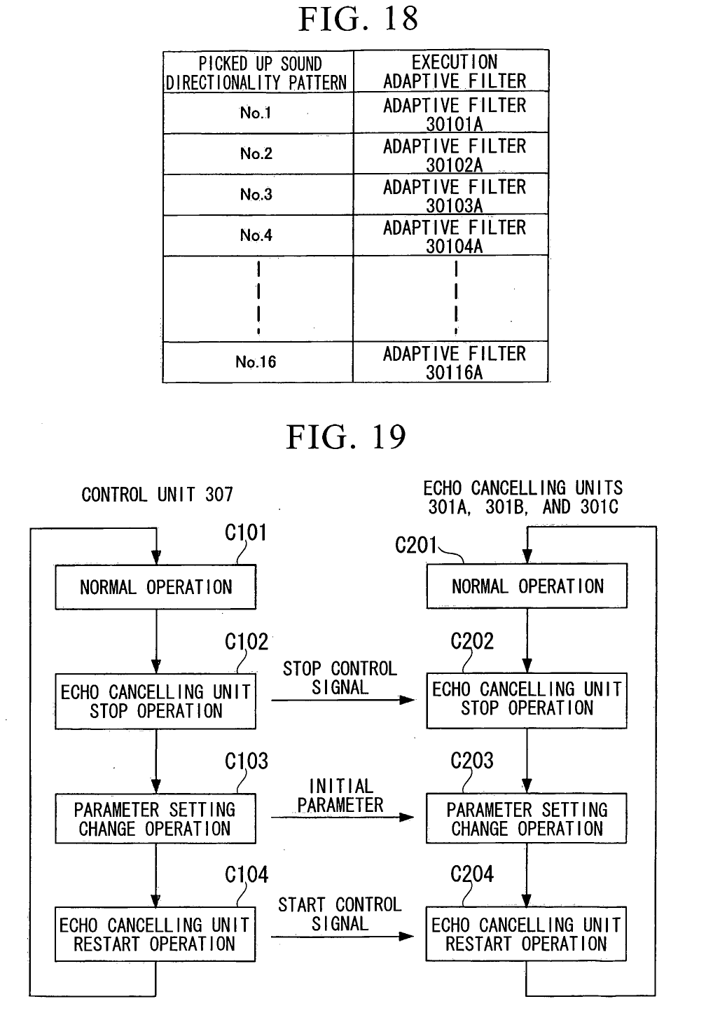

As shown in FIG. 18, the AF switch control unit 3012A previously stores relations between the picked up sound directionalities and the execution adaptive filters which execute the processing.

FIG. 18 shows an association state between the picked up sound directionalities and the execution adaptive filters. In the present description, there is shown a case where 16 picked up sound directionalities from No. 1 to No. 16 are set. However, it is also possible to increase or decrease the number of types of picked up sound directionalities.

Here, for example, when the picked up sound directionality data showing the picked up sound directionality No. 1 is input from the picked up sound directionality control unit 3042, the AF switch control unit 3012A selects the adaptive filter 30101A as the execution adaptive filter. Then, the AF switch control unit 3012A gives a signal output from the first delay control unit 3011A, to the adaptive filter 30101A. Similarly, when the picked up sound directionality data showing the picked up sound directionality No. 1 is input from the picked up sound directionality control unit 3042, the AF switch control unit 3012B (not shown) of the echo cancelling unit 301B selects the adaptive filter 30101B corresponding to this. Furthermore, when the picked up sound directionality data showing the picked up sound directionality No. 1 is input from the picked up sound directionality control unit 3042, the AF switch control unit 3012C (not shown) of the echo cancelling unit 301C selects the adaptive filter 30101C corresponding to this.

The adaptive filter group 3010A comprises adaptive filters 30101A to 30116A which are respectively connected to the AF switch control unit 3012A in parallel, and only the adaptive filter selected by the abovementioned AF switch control unit 3012A executes the processing as the execution adaptive filter. These adaptive filters 30101A to 30116A are realized by, for example a FIR circuit. The number of the adaptive filters constituting the adaptive filter group 3010A is not limited to 16, and it may be constituted by adaptive filters of a number corresponding to the number of the picked up sound directionality patterns set by the echo canceller of the present embodiment. For example, if 8 types of picked up sound directionalities are set, the number of adaptive filters in each echo cancelling unit may be set to 8. In this case, the number of the initial parameters stored in the memory 3070 is also changed according to this number of adaptive filters.

The execution adaptive filter generates a pseudo echo signal from an input sound signal that is input from the first delay control unit 3011A and for which system delay processing has been completed, and gives it to the post processor 3013A.

Moreover, similarly to the echo cancelling unit 301A, the execution adaptive filter in the echo cancelling unit 301B generates a pseudo echo signal from an input sound signal that is input from the first delay control unit 3011B and for which system delay processing has been completed, and gives it to the post processor 3013B. Furthermore, similarly to the echo cancelling units 301A and 301B, the execution adaptive filter in the echo cancelling unit 301C generates a pseudo echo signal from an input sound signal that is input from the first delay control unit 3011C and for which system delay processing has been completed, and gives it to the post processor 3013C.

The post processor 3013A subtracts the pseudo echo signal generated by the execution adaptive filter, from the directional picked up sound signal input from the picked up sound directionality control unit 3042, outputs this subtracted signal to the post processor 3013B in the echo cancelling unit 301B, and then returns it to the execution adaptive filter. The execution adaptive filter sets the parameter again based on the returned signal, and generates the pseudo echo signal.

The post processor 3013B subtracts the pseudo echo signal generated by the execution adaptive filter selected by the AF switch control unit 3012B (not shown), from the output signal of the post processor 3013A, outputs this subtracted signal to the post processor 3013C in the echo cancelling unit 301C, and then returns it to the execution adaptive filter selected by the AF switch control unit 3012B. The execution adaptive filter sets the parameter again based on the returned signal, and generates the pseudo echo signal.

Furthermore, the post processor 3013C subtracts the pseudo echo signal generated by the execution adaptive filter selected by the AF switch control unit 3012C (not shown), from the output signal of the post processor 3013B, outputs this subtracted signal to the sound signal output terminal 305, and then returns it to the execution adaptive filter selected by the AF switch control unit 3012C. The execution adaptive filter sets the parameter again based on the returned signal, and generates the pseudo echo signal.

Such generation of the pseudo echo signal and generation of the subtracted signal are repeatedly performed, so that the parameter of the execution adaptive filter is updated to the optimum one all the time, and the wraparound voice (echo) emitted from the speaker array 3031 and picked up by the microphone array 3041 is attenuated more optimally.

The sound signal output terminal 305 is connected to a LAN or the like, and outputs a signal output from the post processor 3013C in the echo cancelling unit 301C, as an output sound signal, to an external communication network.

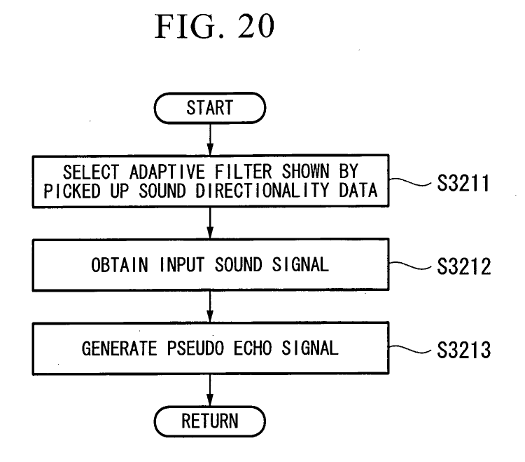

Next is a description of the processing in the case where the emitted sound directionality and the picked up sound directionality are switched, with reference to FIG. 19 and FIG. 20.

FIG. 19 is a state transition diagram for the control unit 307 and the echo cancelling units 301A to 301C, and FIG. 20 shows a processing flow of the echo cancelling unit at the time of normal processing.

At the time of normal processing, that is, in the state where the switch instruction of the emitted sound directionality is not performed, the control unit 307 does not perform any control of the echo cancelling units 301A to 301C (C101).

As mentioned above, the echo cancelling units 301A to 301C generate the pseudo echo signals, while switching the execution adaptive filters, according to the picked up sound directionality data (C201). Specifically, in the case of the echo cancelling unit 301A, according to the picked up sound directionality data obtained from the picked up sound directionality control unit 3042, the echo cancelling unit 301A selects the adaptive filter corresponding to the given picked up sound directionality data, as the execution adaptive filter, among the adaptive filters 30101A to 30116A (S3211). Then, the echo cancelling unit 301A obtains the input sound signal (S3212), and uses the selected execution adaptive filter to generate the pseudo echo signal (S3213).

Next, as described above, if there is a setting input of the emitted sound directionality from the operation input unit 306, the control unit 307 judges whether or not the input emitted sound directionality is different from the currently set emitted sound directionality, and if it is different, performs processing to switch the emitted sound directionality. The control unit 307 firstly generates stop control signals which temporarily stop the processing of the adaptive filters 30101 to 30116, in the echo cancelling units 301A, 301B, and 301C, and then outputs them to the echo cancelling units 301A to 301C (C102).

Upon the receipt of the stop control signals, the echo cancelling units 301A to 301C stop the echo cancelling processing (C202). In this case, the echo cancelling processing may be stopped by stopping the processing of the execution adaptive filter by having the AF switch control unit 3012 in a disconnection state, or by stopping the processing of the first delay control unit 3011. That is, any configuration may be applicable as long as the adaptive filter group 3010 comes to a stop state. Specifically, in the case of the echo cancelling unit 301A, the echo cancelling unit 301A has the AF switch control unit 3012A in a disconnection state, or stops the processing of the first delay control unit 3011A.

When the control unit 307 detects that the echo cancelling units 301A to 301C are stopped, it reads out the initial parameters PAF corresponding to the nominated emitted sound directionality, and respectively gives these to the adaptive filters in the adaptive filter group 3010 in the respective echo cancelling units 301A to 301C (C103). Specifically, if the emitted sound directionality No. 1 is set for the echo cancelling unit 301A, the initial parameters PAF1101 to PAF1116 are respectively given to the adaptive filters 30101A to 30116A.

In the respective adaptive filters 30101 to 30116 in the echo cancelling units 301A to 301C, the given initial parameters PAF are overwritten (C203). Specifically, in the case of the emitted sound directionality No. 1 and the echo cancelling unit 301A, the given initial parameters PAF1101 to PAF1116 are overwritten on the adaptive filters 30101A to 30116A.

Next, when the control unit 307 detects that the parameters are rewritten on the respective adaptive filters 30101 to 30116, it gives start control signals which instruct to restart processing of the echo cancelling units 301A to 301C, to the respective echo cancelling units 301A to 301C (C104).

Upon receipt of the start control signals, the echo cancelling units 301A to 301C again set the adaptive filters that have been selected as the execution adaptive filters at the time of stopping, as the execution adaptive filters (C204). Specifically, in the case of the echo cancelling unit 301A, among the adaptive filters 30101A to 30116A having newly set initial parameters, the echo cancelling unit 301A again sets the adaptive filters 30101A to 30116A that have been selected as the execution adaptive filters at the time of stopping, as the execution adaptive filters.

In this case, by having a configuration where the picked up sound directionality data of the picked up sound directionality control unit 3042 is detected and stored even in a stop state, the echo cancelling units 301A to 301C may also select the adaptive filters 30101 to 30116 corresponding to these obtained and stored picked up sound directionality data, as the execution adaptive filters, at the time of restarting. As a result, execution adaptive filters more accurately corresponding to the picked up sound directionality data in the current state (at the point in time) can be set.

Then, the echo cancelling units 301A to 301C return to the above mentioned normal processing state, and generate pseudo echo signals, while switching the execution adaptive filters, according to the picked up sound directionality data (C201).

If the emitted sound directionality is switched in such a manner, then by temporarily stopping the adaptive filter so as to set the parameter, it becomes possible to prevent a temporary damage state of the adaptive filter, caused by forcibly rewriting the parameter of the execution adaptive filter during the echo cancel processing. As a result, a big echo occurring in this temporary damage state can be prevented. By performing such temporary stopping at the time of switching the emitted sound directionality, although the echo cancelling effect is temporarily eliminated, the echo is infinitely smaller compared to the above big echo.

Moreover, in order to keep this echo from being output, the echo cancelling units 301A to 301C may be completely put in a disconnection state, so as to not output the output sound signal from the sound signal output terminal 305. In any case, the time of parameter setting for switching the emitted sound directionality is extremely short, the emitted sound directionality is set by the user, and the switching frequency is very low compared to the switching of the picked up sound directionality. Therefore, even if the echo signal is small or the sound signal is not output, the output sound signal is hardly affected.

As mentioned above, by using the configuration and the processing of the present embodiment, then even in an acoustic environment where the emitted sound directionality and the picked up sound directionality are switched, in particular an acoustic environment where the picked up sound directionality is frequently switched, it becomes possible to switch to the optimum adaptive filter at a higher speed than the conventional case, and the optimum feedback sound elimination process can be performed in a short time.

In the above description, there is shown a case where, at each time when the emitted sound directionality is switched, the initial parameter stored in the memory 3070 is continually used without being updated. However, it is also possible to update and use the initial parameter stored in the memory 3070. In this case, when the parameter setting change of the adaptive filter is instructed from the control unit 307, the echo cancelling units 301A to 301C read out the parameters of the respective adaptive filters at the point in time, and give them to the control unit 307. The control unit 307 writes the given parameters over the corresponding initial parameters PAF in the memory 3070. Then, if the emitted sound directionality before the present switching is set next, the control unit 307 reads out the initial parameters PAF that have been overwritten and updated, and gives them to the respective adaptive filters 30101 to 30116 in the echo cancelling units 301A to 301C.

By using such a processing method, the parameter setting which is the closest to the current state can be updated and stored all the time for each picked up sound directionality pattern in each emitted sound directionality, and can be set as the initial parameter. As a result, it becomes possible to switch to the optimum adaptive filter at higher speed, and the optimum feedback sound elimination process can be performed in a short time.

Moreover, in the present embodiment, there is shown a case where a plurality of virtual point sound sources are realized. However, even in a case where in reality a plurality of speakers are set to emit sounds, the configuration of the present invention can be applied. Furthermore, if the acoustic space (such as room size and shape) is variable in addition to the emitted sound directionality by the speaker array, the abovementioned configuration can be applied by setting initial parameters including these.

Moreover, in the present embodiment, the filter parameter of each adaptive filter is switched and the execution adaptive filter is selected, according to the emitted sound directionality of the speaker array and the picked up sound directionality of the microphone array. However, the respective embodiments of the present invention are not limited to the directionality control by the array. For example, even if there is only one speaker or one microphone, the present invention is applicable as long as the setting direction can be controlled and detected. Furthermore, even if there are a plurality of independent speaker arrays and microphone arrays, the present invention is similarly applicable.

Moreover, the above description was regarding the echo canceller. However, as long as a device is such that a sound emitted from a speaker is wrapped around (regresses to) a microphone and picked up, the configuration of the present invention may be applied to demonstrate the abovementioned effects. One example thereof includes a howling canceller.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### INDUSTRIAL APPLICABILITY

The invention can be applicable to not only one speaker or microphone but also a speaker array or microphone array that effectively needs to eliminate a feedback sound even when the acoustic environment is rapidly and nonlinearly changed.

1. A feedback sound eliminating apparatus comprising:
a control device which instructs an acoustic environment to a feedback sound eliminating device, and an acoustic environment forming device which includes at least a speaker system and a microphone system, and realizes one of a plurality of acoustic environments; and
a feedback sound eliminating device which generates a pseudo feedback sound signal based on a voice signal to be input into said speaker system, and subtracts said pseudo feedback sound signal from a picked up sound signal output from said microphone system,
wherein said feedback sound eliminating device comprises:
a storage device which stores a plurality of parameters for an adaptive filter, that are set respectively corresponding to said plurality of acoustic environments; and
an adaptive filter which, if an acoustic environment instruction is performed by said control device, reads out the pertinent parameter from said storage device, based on the acoustic environment instruction, generates said pseudo feedback sound signal using the read out parameter, and generates a pseudo feedback sound signal while continuously updating said parameter, based on the result obtained by subtracting a pseudo feedback sound signal at this point in time from the previous picked up sound signal.

2. A feedback sound eliminating apparatus according to claim 1, comprising:
an acoustic environment forming device which includes at least a speaker system and a microphone system, and realizes one of a plurality of acoustic environments;
a feedback sound eliminating device which generates a pseudo feedback sound signal based on a voice signal to be input into said speaker system, and subtracts said pseudo feedback sound signal from a picked up sound signal output from said microphone system; and
a control device which instructs an acoustic environment to said acoustic environment forming device and said feedback sound eliminating device, wherein
said control device comprises a storage device which stores a plurality of parameters for an adaptive filter, that are set respectively corresponding to said plurality of acoustic environments, and upon receipt of switching of the acoustic environment, detects an unused adaptive filter, writes a parameter corresponding to a newly set acoustic environment into the unused adaptive filter, and generates parameter rewriting state data; and
said feedback sound eliminating device comprises a plurality of adaptive filters, and a selecting device which selects one of said plurality of adaptive filters as an execution adaptive filter, and upon detection of said parameter rewriting state data, switches from the currently executed adaptive filter to an adaptive filter having a parameter set corresponding to the new acoustic environment, by means of said selecting device, and generates said pseudo feedback sound signal.

3. A feedback sound eliminating apparatus according to claim 1, comprising:
an emitted sound control device which controls an emitted sound signal to be supplied to a speaker device, so as to give a plurality of styles of emitted sound directionalities to a voice emitted from the speaker device;
a picked up sound control device which controls a picked up sound signal of a microphone device, and generates a directional picked up sound signal having a plurality of styles of picked up sound directionalities;
a feedback sound eliminating device which has a plurality of adaptive filters which generate a pseudo feedback sound signal based on said emitted sound signal, and which subtracts the pseudo feedback sound signal generated by a predetermined adaptive filter, from said directional picked up sound signal; and
a control device which has a storage device which stores initial parameters of the adaptive filter, in respective combinations of said plurality of styles of emitted sound directionalities and said plurality of styles of picked up sound directionalities, and gives initial parameters corresponding to styles of set emitted sound directionality and corresponding to styles of respectively different picked up sound directionalities, to the respective adaptive filters;
wherein said feedback sound eliminating device comprises a selecting device which selects said predetermined adaptive filter, based on the style of the picked up sound directionality set by said picked up sound control device.

4. A feedback sound eliminating apparatus according to claim 1, wherein upon receipt of a new acoustic environment instruction, said adaptive filter updates and stores the currently used parameter in said storage device, and reads out a parameter based on said new acoustic environment instruction.

5. A feedback sound eliminating apparatus according to claim 3, wherein said feedback sound eliminating device detects the presence/absence of said parameter rewriting state data at each previously set predetermined timing, and switches the adaptive filter by means of said selecting device, upon detection of the parameter rewriting state data.

6. A feedback sound eliminating apparatus according to claim 3, wherein said control device does not rewrite on an unused adaptive filter, but only generates the parameter rewriting state data, if said acoustic environment to be newly input matches the acoustic environment before the currently executed acoustic environment.

7. A feedback sound eliminating apparatus according to of claim 1, wherein said control device temporarily stops said feedback sound eliminating device, at the time of switching of the emitted sound directionality, and switches the initial parameters of the respective adaptive filters.

8. A feedback sound eliminating apparatus according to claim 1, wherein
said speaker system is a speaker array;
said acoustic environment is set by the directionality of the speaker; and
the directionality of the speaker array is changed and the parameter of the adaptive filter is switched, according to said acoustic environment instruction.

9. A feedback sound eliminating apparatus according to claim 1, wherein:
said microphone system is a microphone array;
said acoustic environment is set by the directionality of the microphone; and
the directionality of the microphone array is changed and the parameter of the adaptive filter is switched, according to said acoustic environment instruction.

10. A feedback sound eliminating apparatus according to claim 1, wherein:
said speaker system is a speaker array and said microphone system is a microphone array;
said acoustic environment is set by the directionality of the speaker and the directionality of the microphone; and
the directionality of the speaker array and the directionality of the microphone array are changed and the parameter of the adaptive filter is switched, according to said acoustic environment instruction.

11. A feedback sound eliminating apparatus according to claim 9, wherein said picked up sound control device specifies a sound source direction from a picked up sound signal output from said microphone device, and generates a directional picked up sound signal having a high picked up sound directionality in the specified direction, and gives the information of the picked up sound directionality corresponding to the pertinent directional picked up sound signal, to said selecting device.
